(19) United States
(12) Patent Application Publication
(10) Pub. No.: US 2004/0012558 A1
(43) Pub. Date: Jan. 22, 2004

(54) Auxiliary input device

(75) Inventors: Yasuhisa Kisuki, Tokyo (JP); Takenori Kawamata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/298,570

(22) Filed: Nov. 19, 2002

(30) Foreign Application Priority Data
Jul. 17, 2002 (JP) P2002-208152

(51) Int. Cl. G09G 5/00

(52) U.S. Cl. 345/156

(57) ABSTRACT

An auxiliary input device includes an input section having a predetermined contact surface such as a tablet for inputting writing information about a position in which a writing medium is brought into contact with the predetermined contact surface, and a character recognition means for performing character recognition based on the writing information to provide a character recognition result. The auxiliary input device further includes a connection section connectable to an external device such as a portable telephone for sending the top-ranked candidate character of the character recognition result provided from the character recognition means as sending information to the external device when the connection section is connected to the external device.

### BACKGROUND OF THE INVENTION

1. Field of the Invention

The present invention relates to an auxiliary input device for connection to compact equipment such as a portable telephone. More particularly, the invention relates to an auxiliary input device having a handwriting input function, such as a tablet, for efficiency of character input and pointing.

2. Description of the Background Art

The Japanese domestic market for portable telephones exceeded 65 million units as of Oct. 31, 2001, and about 70% of such portable telephones utilize Internet connection services. The users of the Internet connection services have strong needs for efficient input of characters when creating mails or entering URL addresses. Accordingly, there is a demand for auxiliary input devices capable of beginner-friendly efficient character input in place of the current character input using a numeric keypad. Conventional auxiliary input devices of the type externally attached to portable telephones include a compact keyboard which converts keyed information into key event information for a portable telephone to send the key event information to the portable telephone. Such an input device and a portable telephone are disclosed in, for example, Japanese Patent Application Laid-Open No. 2001-159946.

The conventional auxiliary input device employs the compact keyboard which is a downsized version of a conventional external keyboard in consideration for improvements in efficiency of keying by a PC (personal computer) user. Such a compact keyboard is better in portability but more difficult to key than the conventional keyboard. Furthermore, the increase in device size in consideration for the keying efficiency impairs the portability.

A standard keyboard layout (known as a QWERTY keyboard layout) is familiar to PC users, but is difficult to use and requires more keystrokes for nonusers of PCs. The use of a keyboard having a Kana keyboard layout for convenience to nonusers of PCs results in the increased number of keys and impairs the portability.

Moreover, the conventional auxiliary input device has no pointing device function, and accordingly is not capable of graphics-drawing and pointing operations. Thus, the conventional auxiliary input device is disadvantageous in its limited use.

### SUMMARY OF THE INVENTION

It is an object of the present invention to provide an auxiliary input device capable of achieving compatibility between portability and operability.

According to the present invention, an auxiliary input device includes an input section, a character recognition means, and a connection section. The input section inputs writing information about a position in which a writing medium is brought into contact with a predetermined contact surface thereof. The character recognition means recognizes a character based on the writing information to provide a character recognition result. The connection section is connectable to a predetermined external device, and sends, to the predetermined external device, sending information including information about the character recognition result when the connection section is connected to the predetermined external device.

The auxiliary input device is capable of sending the information about the character recognition result based on the writing information to the predetermined external device such as a portable telephone through the connection section. Therefore, the use of the auxiliary input device as a handwriting input device for the predetermined external device enables a user inexperienced in typing on the keyboard of a personal computer and the like to easily enter characters.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an auxiliary input device according to a first preferred embodiment of the present invention;

FIG. 2 is a flowchart showing the procedure of a handwriting input operation using the auxiliary input device according to the first preferred embodiment;

FIG. 3 illustrates a character handwritten on an input section;

FIG. 4 illustrates recognition result candidate characters in tabular form as a result of recognition by a character recognition means;

FIG. 5 illustrates the top-ranked candidate character of the recognition result displayed on a display screen of a portable telephone;

FIG. 6 is a block diagram of the auxiliary input device according to a second preferred embodiment of the present invention;

FIG. 7 is a flowchart showing the procedure of a handwriting input operation using the auxiliary input device according to the second preferred embodiment;

FIG. 8 illustrates a character handwritten on the input section;

FIG. 9 illustrates recognition result candidate characters in tabular form as a result of recognition by the character recognition means;

FIG. 10 illustrates the top-ranked candidate character of the recognition result displayed on the display screen of the portable telephone;

FIG. 11 illustrates the display screen of the portable telephone after the recognition result is corrected using a correction means;

FIG. 12 is a block diagram of the auxiliary input device according to a third preferred embodiment of the present invention;

FIG. 13 is a flowchart showing the procedure of a handwriting input operation using the auxiliary input device according to the third preferred embodiment;

FIG. 14 is a block diagram of the auxiliary input device according to a fourth preferred embodiment of the present invention;

FIG. 15 is a flowchart showing the procedure of a handwriting input operation and a stored data sending process using the auxiliary input device according to the fourth preferred embodiment;

FIG. 16 illustrates a character handwritten on the input section;

FIG. 17 illustrates candidate characters of a character recognition result obtained by the character recognition means;

FIG. 18 illustrates the candidate characters of the character recognition result for the first character stored in a storage means;

FIG. 19 illustrates a character handwritten on the input section;

FIG. 20 illustrates candidate characters of a character recognition result obtained by the character recognition means;

FIG. 21 illustrates candidate characters of character recognition results for two characters stored in a storage means;

FIG. 22 illustrates the top-ranked candidate character of the recognition result for the first character displayed on the display screen of the portable telephone;

FIG. 23 illustrates the top-ranked candidate characters of the recognition results for two characters displayed on the display screen of the portable telephone;

FIG. 24 is a block diagram of the auxiliary input device according to a fifth preferred embodiment of the present invention;

FIG. 25 is a flowchart showing the procedure of a handwriting input operation using the auxiliary input device according to the fifth preferred embodiment;

FIG. 26 illustrates a character handwritten on the input section with a fingernail tip;

FIG. 27 shows strokes of an input pattern which are connected together by the character recognition means;

FIG. 28 illustrates candidate characters of a character recognition result obtained by the character recognition means recognizing a character pattern written on the input section;

FIG. 29 is a flowchart showing a flow of a determination process by a writing medium determination means;

FIG. 30 illustrates how the writing medium determination means determines a writing medium, based on a written pattern;

FIG. 31 is a flowchart showing a flow of the process of a candidate character rearrangement means;

FIG. 32 illustrates a recognition result after the candidate character rearrangement means performs a rearrangement process on the previous top-ranked candidate character of a recognition result;

FIG. 33 illustrates recognition result candidate characters after the candidate character rearrangement means performs the rearrangement process on all recognition result candidate characters;

FIG. 34 illustrates a character (Hiragana character “te”) handwritten on the input section with the ball of a finger;

FIG. 35 shows strokes of a written pattern which are connected together by the character recognition means;

FIG. 36 illustrates a character recognition result in tabular form obtained by the character recognition means recognizing a pattern written on the input section;

FIG. 37 illustrates a pressure distribution at the starting point of an input pattern;

FIG. 38 is a block diagram of the auxiliary input device according to a sixth preferred embodiment of the present invention;

FIG. 39 is a flowchart showing the procedure of a handwriting input operation using the auxiliary input device according to the sixth preferred embodiment;

FIG. 40 is a block diagram of the auxiliary input device according to a seventh preferred embodiment of the present invention;

FIG. 41 is a flowchart showing the procedure of a handwriting input operation using the auxiliary input device according to the seventh preferred embodiment;

FIG. 42 illustrates coordinate axes of the input section;

FIG. 43 is a block diagram of the auxiliary input device according to an eighth preferred embodiment of the present invention;

FIG. 44 is a flowchart showing the procedure of a handwriting input operation using the auxiliary input device according to the eighth preferred embodiment;

FIG. 45 illustrates an example of generation of relative coordinate data from input data;

FIG. 46 is a block diagram of the auxiliary input device according to a ninth preferred embodiment of the present invention;

FIG. 47 is a flowchart showing the procedure of a handwriting input operation using the auxiliary input device according to the ninth preferred embodiment;

FIG. 48 is a block diagram of the auxiliary input device according to a tenth preferred embodiment of the present invention;

FIG. 49 is a flowchart showing the procedure of a handwriting input operation using the auxiliary input device according to the tenth preferred embodiment;

FIG. 50 illustrates a character (Hiragana character “he”) handwritten on the input section;

FIG. 51 illustrates recognition result candidate characters as a result of recognition by the character recognition means;

FIG. 52 illustrates the top-ranked candidate character of the recognition result displayed on the display screen of the portable telephone;

FIG. 53 illustrates recognition result candidate characters when a character input mode is not limited;

FIG. 54 is a block diagram of the auxiliary input device according to an eleventh preferred embodiment of the present invention;

FIG. 55 is a flowchart showing the procedure of a handwriting input operation using the auxiliary input device according to the eleventh preferred embodiment;

FIG. 56 illustrates a Chinese Kanji character written as an input pattern on the input section;

FIG. 57 illustrates recognition result candidate characters as a result of recognition by the character recognition means;

FIG. 58 illustrates a Chinese Kanji character displayed on the display screen of the portable telephone;

FIG. 59 is a block diagram of the auxiliary input device according to a twelfth preferred embodiment of the present invention;

FIG. 60 is a flowchart showing the procedure of a handwriting input operation using the auxiliary input device according to the twelfth preferred embodiment;

FIG. 61 illustrates an input pattern written on the input section;

FIG. 62 illustrates recognition result candidate characters as a result of recognition by the character recognition means;

FIG. 63 illustrates the top-ranked candidate character of the recognition result displayed on the display screen of the portable telephone;

FIG. 64 is a block diagram of the auxiliary input device according to a thirteenth preferred embodiment of the present invention;

FIG. 65 is a flowchart showing the procedure of a handwriting input operation using the auxiliary input device according to the thirteenth preferred embodiment;

FIG. 66 is a block diagram of the auxiliary input device according to a fourteenth preferred embodiment of the present invention;

FIG. 67 is a flowchart showing the procedure of a handwriting input operation using the auxiliary input device according to the fourteenth preferred embodiment;

FIG. 68 illustrates an example of a conversion table for use in a conversion process by a control code conversion means;

FIG. 69 is a block diagram of the auxiliary input device according to a fifteenth preferred embodiment of the present invention;

FIG. 70 is a flowchart showing the procedure of a handwriting input operation using the auxiliary input device according to the fifteenth preferred embodiment;

FIG. 71 illustrates a Kanji input pattern written on the input section;

FIG. 72 illustrates recognition result candidate characters and their stroke counts as a result of recognition by the character recognition means;

FIG. 73 illustrates the top-ranked candidate character of the recognition result displayed on the display screen of the portable telephone;

FIG. 74 illustrates the display screen of the portable telephone after the recognition result is corrected using the correction means;

FIG. 75 is a block diagram of the auxiliary input device according to a sixteenth preferred embodiment of the present invention;

FIG. 76 is a flowchart showing the procedure of a handwriting input operation using the auxiliary input device according to the sixteenth preferred embodiment;

FIG. 77 is a flowchart showing a flow of the process of a power management means making a transition from a normal operating state to a low-power-consumption standby state;

FIG. 78 is a flowchart showing a flow of the process of the power management means making a transition from the low-power-consumption standby state to the normal operating state;

FIGS. 79 and 80 illustrate a connection section and its surroundings according to a seventeenth preferred embodiment of the present invention;

FIG. 81 illustrates a first example of the portable telephone;

FIG. 82 illustrates a second example of the portable telephone;

FIG. 83 is a block diagram of the auxiliary input device according to an eighteenth preferred embodiment of the present invention;

FIG. 84 is a flowchart showing the procedure of a signature identification process using the auxiliary input device according to the eighteenth preferred embodiment;

FIG. 85 illustrates the first character of a signature written on the input section; and

FIG. 86 illustrates the second character of the signature written on the input section.

### DESCRIPTION OF THE PREFERRED EMBODIMENTS

First Preferred Embodiment

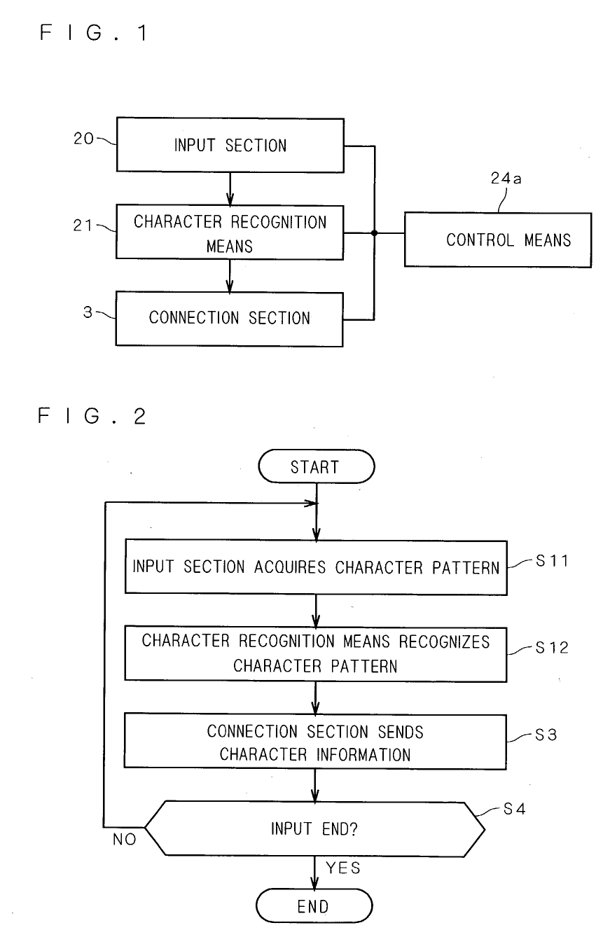

FIG. 1 is a block diagram of an auxiliary input device according to a first preferred embodiment of the present invention. As shown in FIG. 1, the auxiliary input device according to the first preferred embodiment comprises an input section 20, a character recognition means 21, a connection section 3, and a control means 24a.

The input section 20 has a predetermined contact surface of a tablet and the like, and inputs writing information about a position in which a writing medium is brought into contact with the predetermined contact surface. The character recognition means 21 performs character recognition based on the writing information outputted from the input section 20 to provide a character recognition result. The control means 24a controls the input section 20, the character recognition means 21 and the connection section 3.

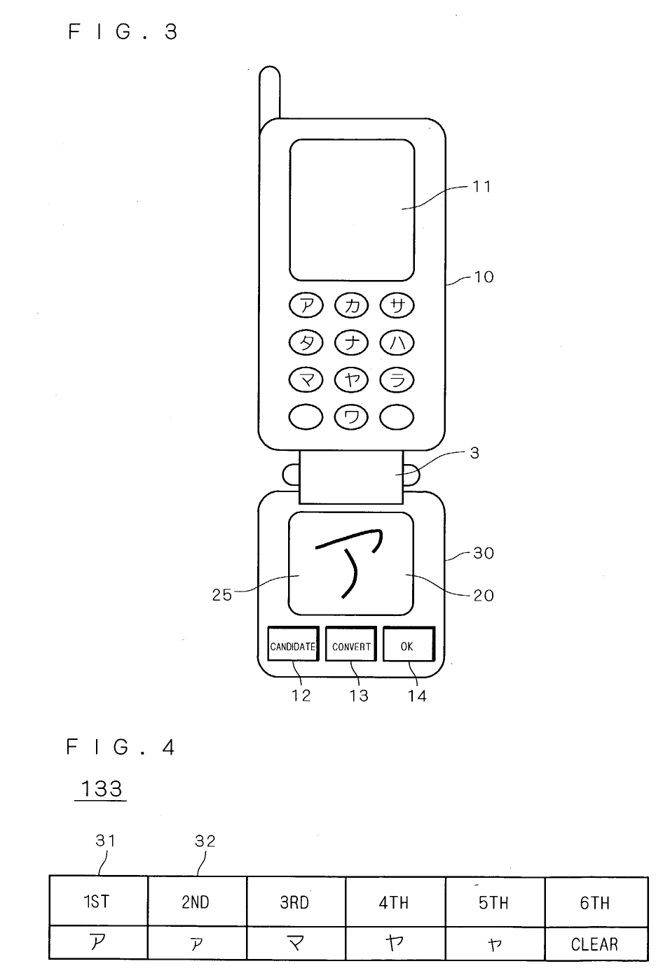

FIG. 2 is a flowchart showing the procedure of a handwriting input operation using the auxiliary input device according to the first preferred embodiment. This process is performed under the control of the control means 24a.

FIG. 3 illustrates a character 25 (Katakana character “a”) handwritten on the input section 20. Referring to FIG. 3, the connection section 3 of the auxiliary input device 30 according to the first preferred embodiment is connectable to a portable telephone 10, and can send sending information including information about the character recognition result of the character recognition means 21 to the portable telephone 10 when connected to the portable telephone 10.

The portable telephone 10 has a display screen 11 in an upper portion thereof. The auxiliary input device 30 has the input section 20 such as a tablet on an central principal portion of the surface thereof, and a candidate button 12, a conversion button 13 and an OK button 14 in a peripheral portion thereof. The candidate button 12 is used for selection among a plurality of candidate characters, and the conversion button 13 is used for conversion into Kanji characters and the like. The OK button 14 is used to confirm or determine the selection of a candidate character, and so on.

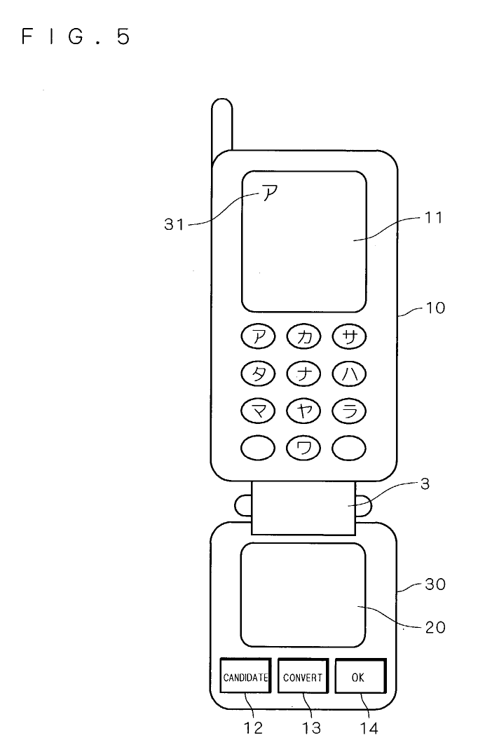

FIG. 4 illustrates a character recognition result in tabular form as a result of recognition by the character recognition means 21. As illustrated in FIG. 4, the character recognition result 133 has a plurality of candidate characters, e.g. a top-ranked candidate character 31 which is a Katakana character “a” and a second-ranked candidate character 32 which is a small Katakana character “a.” FIG. 5 illustrates the top-ranked candidate character 31 (Katakana character “a”) of the recognition result displayed on the display screen 11 of the portable telephone 10 through the connection section 3.

The handwriting input operation using the auxiliary input device according to the first preferred embodiment will be described with reference to FIG. 2. As a precondition, the auxiliary input device 30 is connected through the connection section 3 to the portable telephone 10 for data transmission, as illustrated in FIG. 3. Then, a user writes a character on the input section 20 of the auxiliary input device 30 with a writing medium such as a pen.

In this condition, the control means 24a acquires the character written on the input section 20 as a character pattern or writing information detected by the input section in Step S11. It is assumed that the control means 24a acquires the character pattern of the handwritten character 25 (Katakana character “a”), as shown in FIG. 3.

Next, in Step S12, the control means 24a sends the character pattern obtained by the input section 20 to the character recognition means 21. The character recognition means 21 recognizes the obtained character pattern to output a character recognition result by using an on-line character recognition technique disclosed in, for example, Japanese Patent Application Laid-Open No. 9-198466 (1997) entitled “Method of and Device for On-line Character Recognition.” In this preferred embodiment, it is assumed that the character recognition result 133 shown in FIG. 4 is obtained.

Next, in Step S3, the control means 24a sends character information about the top-ranked candidate character 31 included in the character recognition result obtained by the character recognition means 21 to the connection section 3, and the connection section 3 sends the character information about the top-ranked candidate character 31 as sending information to the portable telephone 10. In the first preferred embodiment, the character information indicating the top-ranked candidate character 31 (Katakana character “a”) is sent to the portable telephone 10, and the top-ranked candidate character 31 (Katakana character “a”) is displayed on the display screen 11 of the portable telephone, as shown in FIG. 5. The above-mentioned character information may be in any form recognizable by the portable telephone 10.

Next, in Step S4, the control means 24a judges whether or not input is terminated. If input is not terminated, the process returns to Step S11. If input is terminated, the process is terminated. The input termination is detected, for example, by the expiration of a predetermined time interval during which no handwriting operation is performed on the input section 20.

Thus, the first preferred embodiment is adapted to send only the top-ranked candidate character included in the character recognition result. However, if the portable telephone is capable of holding all of the candidate characters included in the character recognition result, all of the candidate characters may be sent as a single unit of sending information to the portable telephone.

Although the character recognition result is illustrated as including only Kana characters in the first preferred embodiment, other character codes such as Kanji characters may be sent as a result of character recognition directly to the portable telephone.

As described above, the auxiliary input device according to the first preferred embodiment comprises the input section 20 capable of inputting a handwritten character and the character recognition means 21 for recognizing and coding the handwritten character pattern, and is capable of inputting the character recognition result through the connection section 3 to the portable telephone. Therefore, the auxiliary input device is reduced in size as compared with keyboards, and has improved portability. Additionally, the connection between the connection section 3 and the portable telephone 10 may be a wireless connection to improve operability.

The auxiliary input device according to the first preferred embodiment can input characters by handwriting, thereby to enable nonusers of PCs to easily enter characters.

In the first preferred embodiment, the top-ranked candidate character information (top-priority character information) having the highest priority of all input characters included in the character recognition result is automatically sent to the portable telephone 10. Therefore, the first preferred embodiment is achieved with a relatively simple configuration.

Second Preferred Embodiment

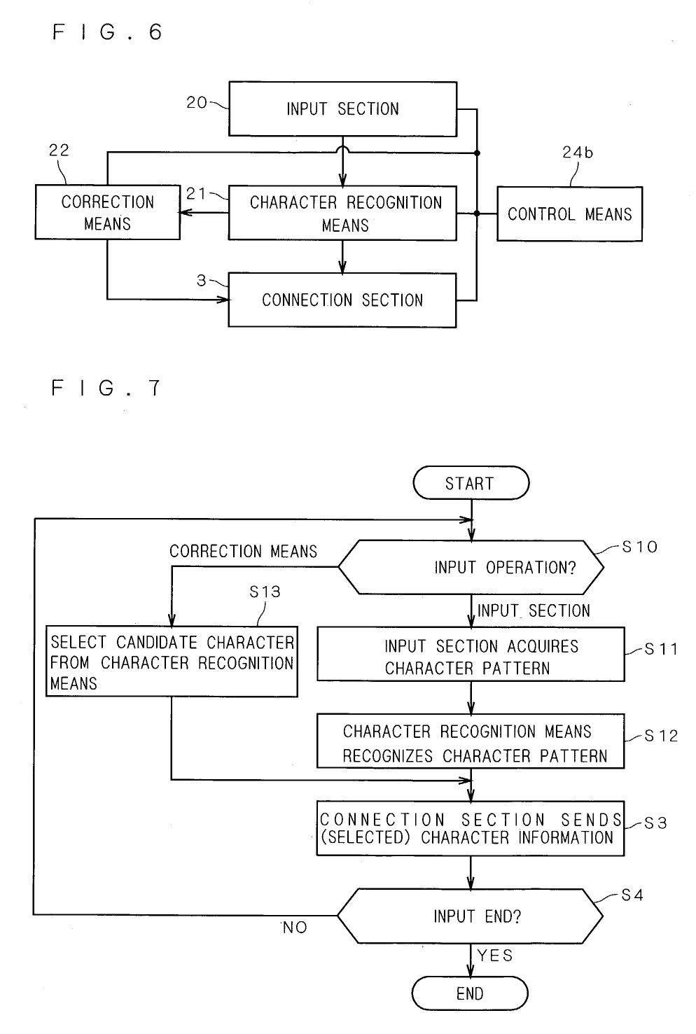

FIG. 6 is a block diagram of the auxiliary input device according to a second preferred embodiment of the present invention. As shown in FIG. 6, the auxiliary input device according to the second preferred embodiment comprises the input section 20, the character recognition means 21, the connection section 3, a correction means 22, and a control means 24b.

Referring to FIG. 6, if the top-ranked candidate character of the character recognition result is incorrect, the user uses the correction means 22 to select among the second-ranked and its subsequent candidate characters, while pressing the candidate button 12, thereby to correct the selected character information as information to be sent. In other words, the correction means 22 functions as a character selection means for selecting one character among the plurality of candidate characters. The control means 24b controls the input section 20, the character recognition means 21, the connection section 3 and the correction means 22. The remaining structure of the second preferred embodiment is similar to that of the first preferred embodiment shown in FIG. 1, and is not particularly described.

FIG. 7 is a flowchart showing the procedure of a handwriting input operation (including the character correction process) using the auxiliary input device according to the second preferred embodiment. This process is performed under the control of the control means 24b.

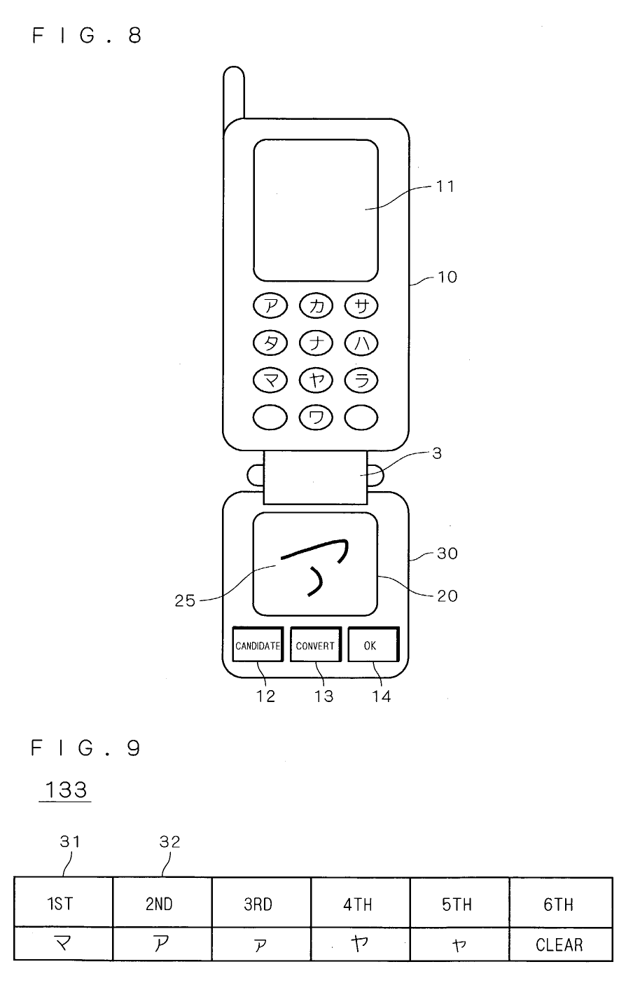

FIG. 8 illustrates the character 25 (Katakana character “a”) handwritten on the input section 20. The candidate button 12 is used for selection of a candidate character, and the conversion button 13 is used for conversion into a Kanji character, and the like. The OK button 14 is used to confirm or determine a converted character, a selected candidate character, and the like.

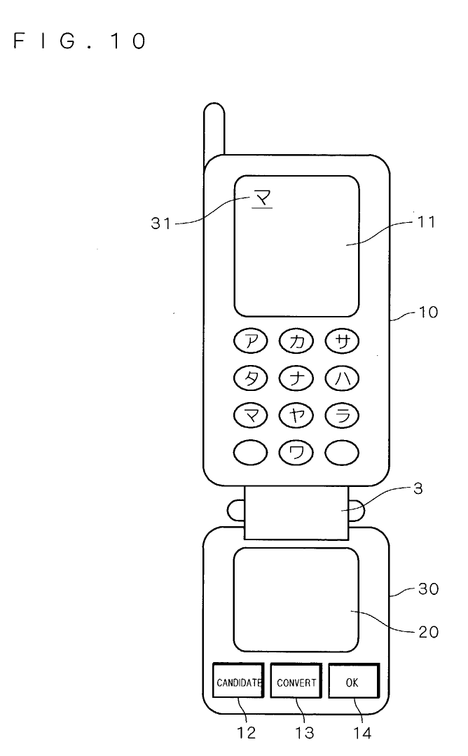

FIG. 9 illustrates a plurality of candidate characters of a character recognition result in tabular form which are recognized by the character recognition means 21.

FIG. 10 illustrates the top-ranked candidate character 31 (Katakana character “ma”) of the character recognition result displayed on the display screen 11 of the portable telephone 10 through the connection section 3.

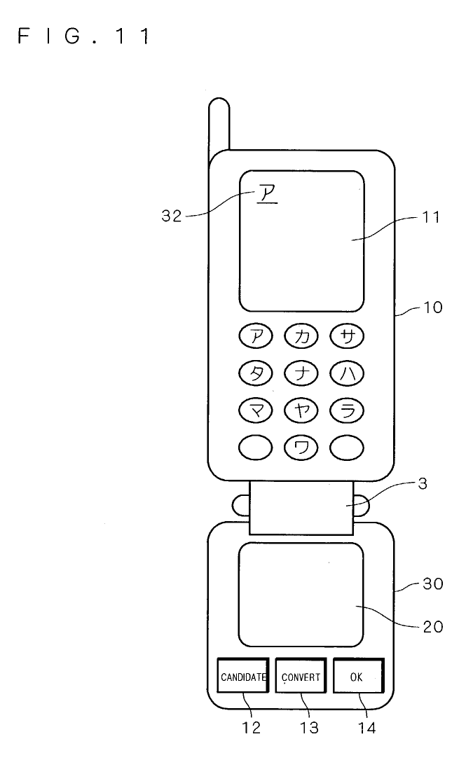

FIG. 11 illustrates the display screen 11 of the portable telephone 10 after correction using the correction means 22.

The handwriting input operation using the auxiliary input device according to the second preferred embodiment will be described with reference to FIG. 7. The precondition of the second preferred embodiment is identical with that of the first preferred embodiment.

First, in Step S10, the control means 24b examines which means was used for input operation. If the correction means 22 was used, the process proceeds to Step S113. If the input section 20 was used, the process proceeds to Step S11. It is assumed in this preferred embodiment that the input section 20 was used first for handwriting and the process proceeds to Step S11.

In Step S11, the control means 24b controls the input section 20 to acquire a character pattern. It is assumed that the character pattern of the handwritten character 25 (Katakana character “a”) is acquired.

Next, in Step S12, the control means 24b sends the character pattern obtained by the input section 20 to the character recognition means 21, as in the first preferred embodiment. The character recognition means 21 outputs a character recognition result. It is assumed in this preferred embodiment that the character recognition result 133 shown in FIG. 9 is obtained.

Next, in Step S3, the control means 24b sends character information about the top-ranked candidate character 31 among the plurality of candidate characters of the character recognition result obtained by the character recognition means 21 to the connection section 3, and the connection section 3 sends the character information about the top-ranked candidate character 31 to the portable telephone 10. In the second preferred embodiment, the top-ranked candidate character 31 (Katakana character “ma”) is sent to the portable telephone 10 and displayed on the display screen 11, as shown in FIG. 10.

Next, in Step S4, the control means 24b judges whether or not input is terminated. It is assumed that input is not terminated and the process returns to Step The input operation is judged in Step S10. In this preferred embodiment, the top-ranked candidate character 31 (Katakana character “ma”) of the character recognition result displayed on the display screen 11 of the portable telephone 10 is an incorrect character. Then, it is assumed that the user presses the candidate button 12 of the correction means 22 to correct the character recognition result, and the process proceeds to Step S13.

In Step S13, the control means 24b gives an instruction to the correction means 22, and the correction means 22 acquires the next candidate character from the character recognition means 21. In this preferred embodiment, the user presses the candidate button 12 once and then presses the OK button 14 to determined the character, whereby the correction means 22 selects the second-ranked candidate character 32 (Katakana character “a”), and the control means 24b acquires information (selected character information) about the second-ranked candidate character 32 (Katakana character “a”).

Then, in Step S3, the control means 24b gives an instruction to the correction means 22, and the correction means 22 sends character string information including a control code indicating one-character deletion and the selected character information to the connection section 3. The connection section 3 sends the character string information as the sending information to the portable telephone 10. In this preferred embodiment, the control code indicating one-character deletion is sent to the portable telephone 10, thereby to cause the top-ranked candidate character 31 (Katakana character “ma”) shown in FIG. 10 to be deleted. Then, the character information about the second-ranked candidate character 32 (Katakana character “a”) is sent to the portable telephone 10, thereby to cause the second-ranked candidate character 32 (Katakana character “a”) to be displayed on the display screen 11 of the portable telephone 10 as shown in FIG. 11. Thus, the correction is made to provide the correct character intended by the user.

Next, in Step S4, the control means 24b judges whether or not input is terminated. It is assumed that input is terminated and the process is terminated.

Thus, the second preferred embodiment is adapted to send only the single character included in the character recognition result. However, if the portable telephone is capable of holding all of the candidate characters included in the character recognition result, all of the candidate characters may be sent as a single unit of sending information to the portable telephone.

Although the character recognition result is illustrated as including only Kana characters in the second preferred embodiment, other character codes such as Kanji characters may be sent as a result of character recognition directly to the portable telephone.

As described above, the auxiliary input device according to the second preferred embodiment comprises the correction means 22. If the top-ranked candidate character of the character recognition result is incorrect, the correction means 22 is capable of correcting the incorrect character by replacing the character displayed on the display screen 11 of the portable telephone 10 with one of the second-ranked and its subsequent candidate characters. Therefore, the auxiliary input device allows a character desired by the user to correctly appear on the display screen 11 of the portable telephone 10.

Then, the auxiliary input device according to the second preferred embodiment allows the input of a handwritten character without the need to change the interface between the portable telephone 10 and the connection section 3 or to add an additional function to the portable telephone 10, thereby improving general versatility.

Third Preferred Embodiment

FIG. 12 is a block diagram of the auxiliary input device according to a third preferred embodiment of the present invention. As shown in FIG. 12, the auxiliary input device according to the third preferred embodiment comprises the input section 20, the character recognition means 21, a key code generation means 2, the connection section 3, the correction means 22, and a control means 24c.

The key code generation means 2 generates a key code corresponding to a character included in a character recognition result obtained by the character recognition means 21. For example, when a Romaji character “A” is recognized, a key code indicating a Romaji character “A” or a Katakana character “a” is generated. The control means 24c controls the input section 20, the character recognition means 21, the key code generation means 2, the connection section 3 and the correction means 22. The remaining structure of the third preferred embodiment is similar to that of the second preferred embodiment shown in FIG. 6.

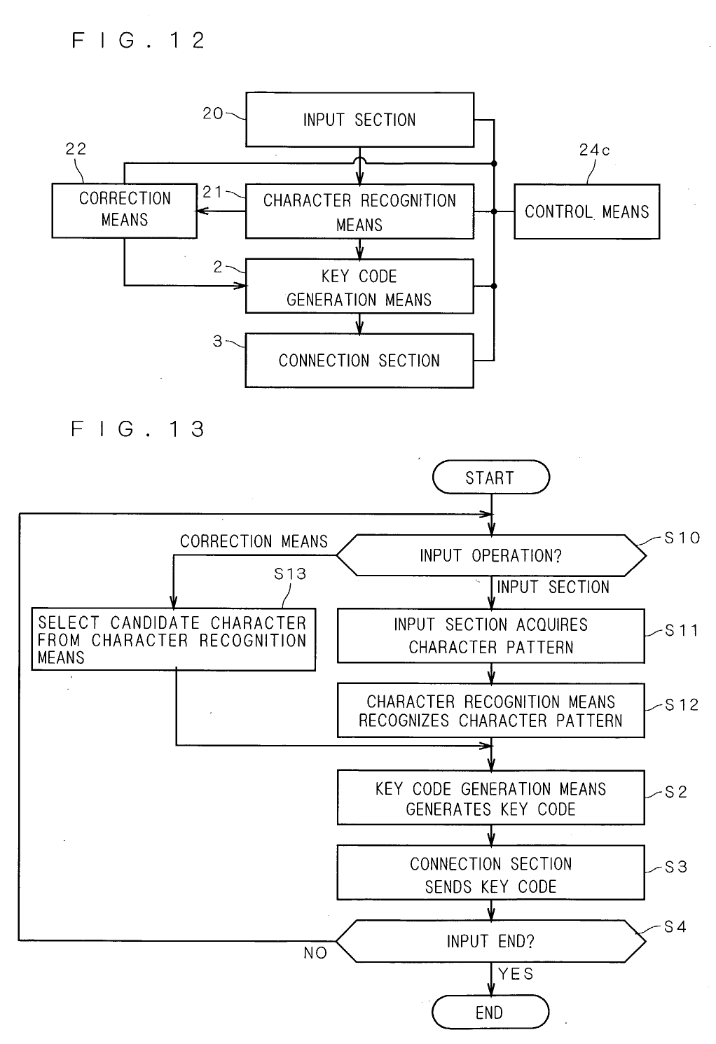

FIG. 13 is a flowchart showing the procedure of a handwriting input operation (including the correction process) using the auxiliary input device according to the third preferred embodiment. This process is performed under the control of the control means 24c. The precondition of the third preferred embodiment is identical with that of the first and second preferred embodiments.

First, in Step S10, the control means 24c examines which means was used for input operation. If the correction means 22 was used, the process proceeds to Step S113. If the input section 20 was used, the process proceeds to Step S111. It is assumed in this preferred embodiment that the input section 20 was used for handwriting and the process proceeds to Step S11.

In Step S11, the control means 24c controls the input section 20 to acquire a character pattern. It is assumed that the character pattern of the handwritten character 25 (Katakana character “a”) is acquired.

Next, in Step S12, the control means 24c sends the character pattern obtained by the input section 20 to the character recognition means 21. The character recognition means 21 outputs a character recognition result. It is assumed in this preferred embodiment that the character recognition result shown in FIG. 4 is obtained, as in the first preferred embodiment.

Then, in Step S2, the control means 24c sends information about the top-ranked candidate character included in the character recognition result obtained by the character recognition means 21 to the key code generation means 2, and the key code generation means 2 generates a corresponding key code for the portable telephone 10 from the information about the top-ranked candidate character. It is assumed in this preferred embodiment that a key code specifying the top-ranked candidate character 31 (Katakana character “a”) is generated. The key code as used in this preferred embodiment means a generally standardized character code for use by the portable telephone 10, and the like.

Next, in Step S3, the control means 24c sends the key code generated by the key code generation means 2 to the connection section 3, and the connection section 3 sends the key code to the portable telephone 10. In this preferred embodiment, the key code indicating the top-ranked candidate character 31 (Katakana character “a”) is sent as the sending information to the portable telephone 10, and the top-ranked candidate character 31 (Katakana character “a”) is displayed on the display screen 11, as shown in FIG. 5.

Next, in Step S4, the control means 24c judges whether or not input is terminated. It is assumed that input is terminated and the process is terminated. The process in Step S13 is identical with that of the second preferred embodiment shown in FIG. 7.

Thus, the third preferred embodiment is adapted to send only the single character included in the character recognition result. However, if the portable telephone is capable of holding all of the candidate characters included in the character recognition result, all of the candidate characters may be sent as a single unit of sending information to the portable telephone.

As described above, the auxiliary input device according to the third preferred embodiment comprises the key code generation means 2, and sends the key code for use by the portable telephone 10 to the portable telephone 10. This allows the input of a handwritten character without the need to change the interface between the portable telephone 10 and the connection section 3, thereby improving general versatility. In other words, the auxiliary input device according to the third preferred embodiment can send the efficient error-free sending information to the portable telephone 10.

Additionally, the auxiliary input device according to the third preferred embodiment can input characters by handwriting, thereby to enable nonusers of PCs to easily enter characters.

Fourth Preferred Embodiment

FIG. 14 is a block diagram of the auxiliary input device according to a fourth preferred embodiment of the present invention. The auxiliary input device according to the fourth preferred embodiment comprises the input section 20, the character recognition means 21, the connection section 3, a storage means 130, and a control means 24d. The storage means 130 stores character recognition results therein, and the control means 24d controls the input section 20, the character recognition means 21, the connection section 3, and the storage means 130. The remaining structure of the fourth preferred embodiment is similar to that of the first preferred embodiment shown in FIG. 1.

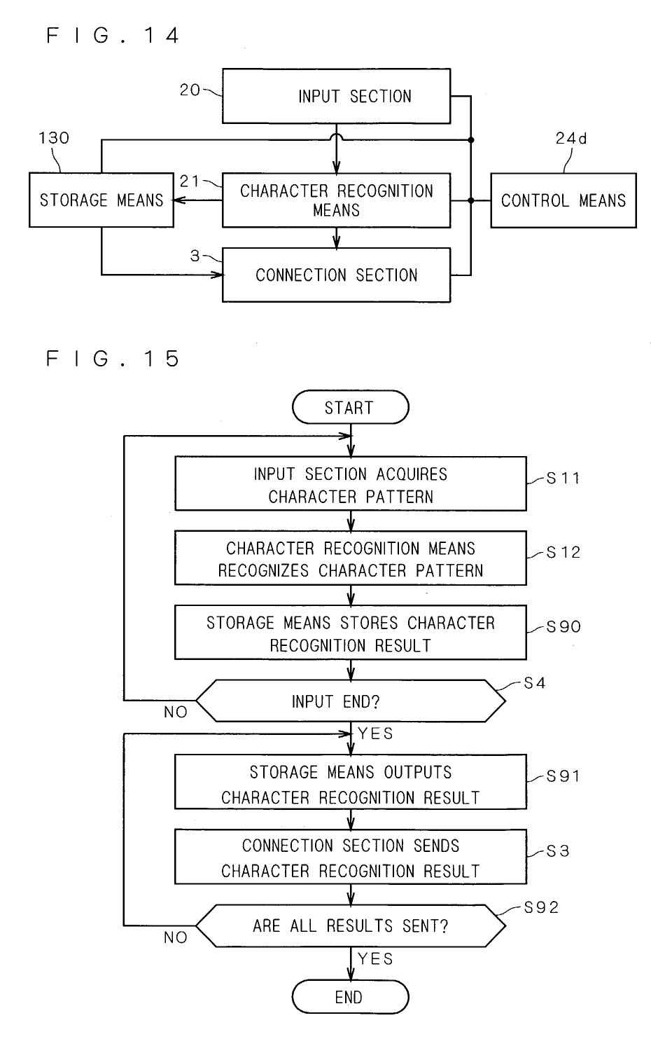

FIG. 15 is a flowchart showing the procedure of a handwriting input operation and a stored data sending process using the auxiliary input device according to the fourth preferred embodiment. These processes are performed under the control of the control means 24d. The precondition of the fourth preferred embodiment is identical with that of the first to third preferred embodiments.

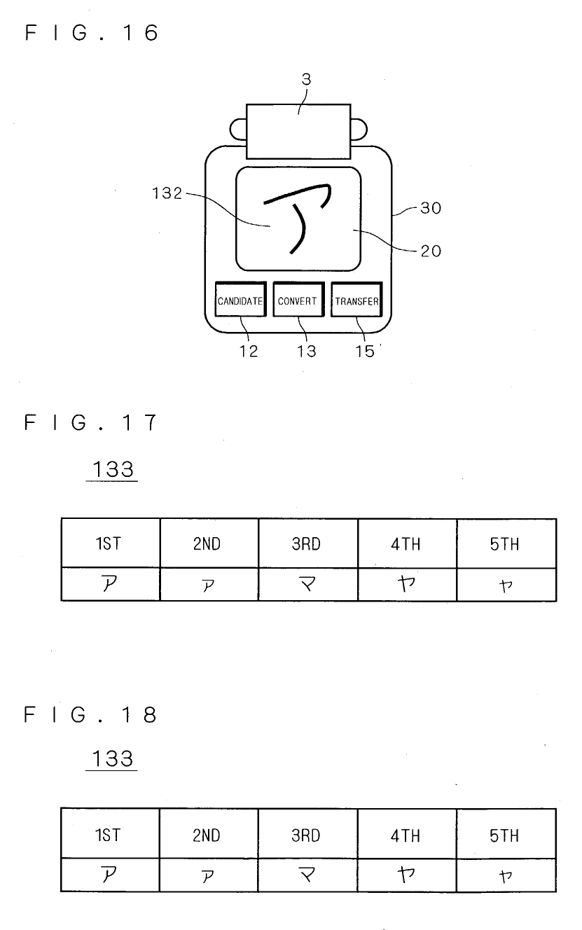

FIG. 16 illustrates a character handwritten on the input section 20. As illustrated in FIG. 16, a handwritten character 132 (Katakana character “a”) appears on the input section 20. A transfer button 15 is provided in place of the OK button 14.

FIG. 17 illustrates a plurality of candidate characters of a character recognition result in tabular form obtained by the character recognition means 21. The character recognition result 133 includes the top-ranked (first-ranked) to fifth-ranked candidate characters.

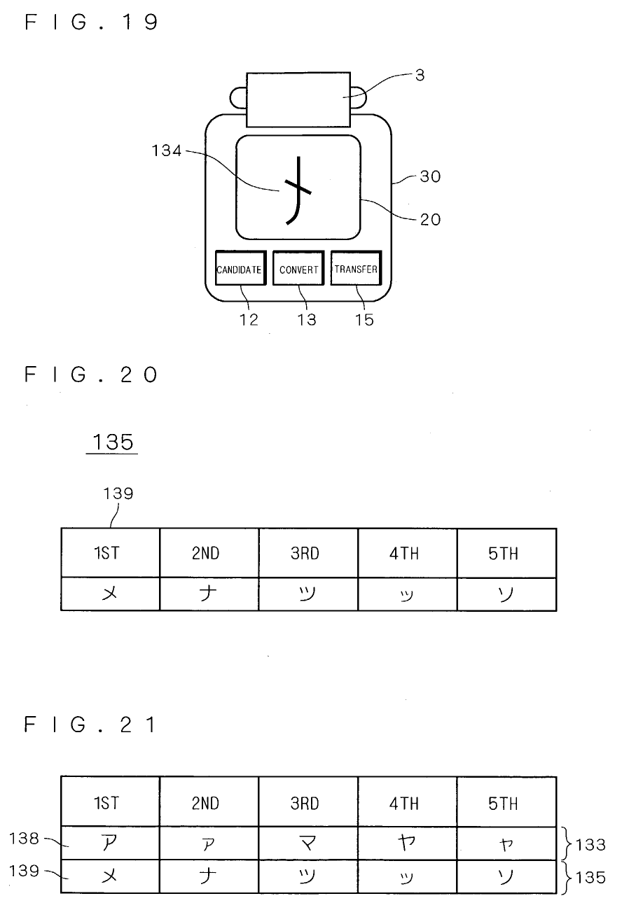

FIG. 18 illustrates the plurality of candidate characters of the character recognition result in tabular form for the first character stored in the storage means 130.

FIG. 19 illustrates a character handwritten on the input section 20. As illustrated in FIG. 19, a handwritten character 134 (Katakana character “me”) appears on the input section 20.

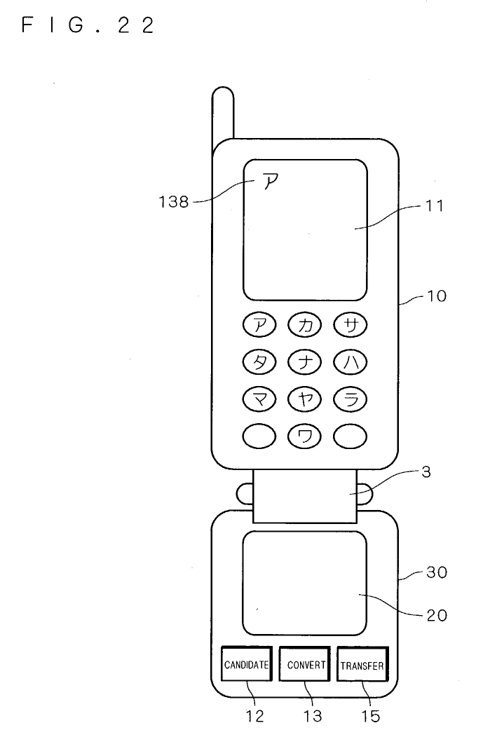

FIG. 20 illustrates a plurality of candidate characters of a character recognition result obtained by the character recognition means 21. A recognition result 135 includes the top-ranked (first-ranked) to fifth-ranked candidate characters.

FIG. 21 illustrates the plurality of candidate characters of the character recognition results for two characters stored in the storage means 130. As shown in FIG. 21, the character recognition result 133 and the recognition result 135 are stored in the storage means 130. The top-ranked candidate character 138 of the character recognition result 133 is the Katakana character “a” and the top-ranked candidate character 139 of the recognition result 135 is the Katakana character “me.”

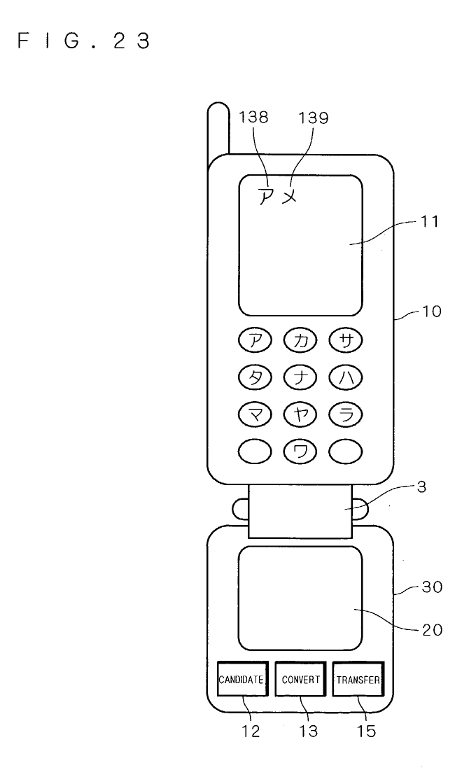

FIG. 22 illustrates the top-ranked candidate character 138 (Katakana character “a”) displayed on the display screen 11 of the portable telephone 10 through the connection section 3.

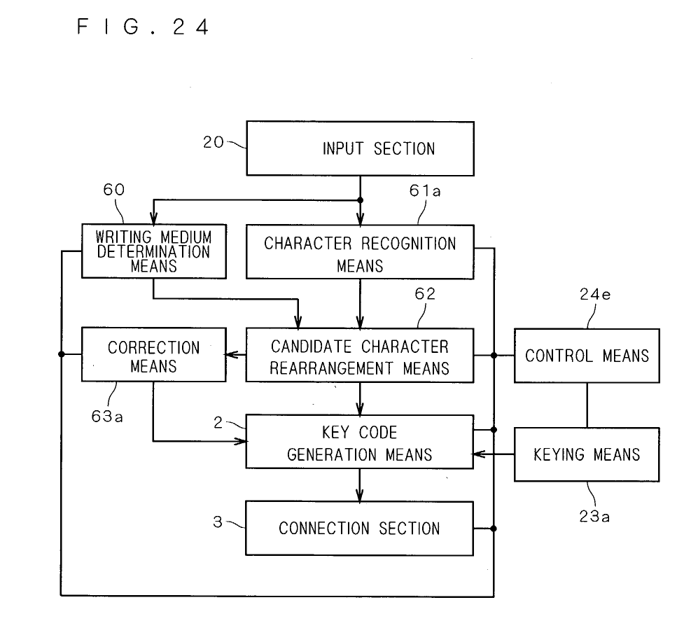

FIG. 23 illustrates a string of the top-ranked candidate characters 138 and 139 (Katakana characters “a” and “me”) of the character recognition results for two characters displayed on the display screen 11 of the portable telephone 10 through the connection section 3.

The operation of the fourth preferred embodiment will be described with reference to FIG. 15.

In Step S11, the control means 24d controls the input section 20 to acquire a character pattern. It is assumed that the character pattern of the handwritten character 132 (Katakana character “a”) shown in FIG. 16 is acquired.

Next, in Step S12, the control means 24d sends the character pattern obtained by the input section 20 to the character recognition means 21. The character recognition means 21 recognizes the obtained character pattern to output a character recognition result. It is assumed in this preferred embodiment that the character recognition result 133 shown in FIG. 17 is obtained.

Then, in Step S90, the control means 24d gives an instruction to the storage means 130, and the storage means 130 stores therein all candidate characters of the character recognition result obtained by the character recognition means 21, as illustrated in FIG. 18.

Next, in Step S4, the control means 24d judges whether or not input is terminated. If input is terminated, the process proceeds to Step S91. If input is not terminated, the process returns to Step S11. It is assumed that input is not terminated and the process returns to Step S11.

In Step S11, the control means 24d controls the input section 20 to acquire the next character pattern. It is assumed that the character pattern of the handwritten character 134 (Katakana character “me”) shown in FIG. 19 is acquired.

Next, in Step S12, the control means 24d sends the character pattern obtained by the input section 20 to the character recognition means 21. The character recognition means 21 recognizes the obtained character pattern to output a character recognition result. It is assumed in this preferred embodiment that the character recognition result 135 shown in FIG. 20 is obtained.

Then, in Step S90, the control means 24d gives an instruction to the storage means 130, and the storage means 130 stores therein the candidate characters of the character recognition result obtained by the character recognition means 21. In this manner, the character recognition results 133 and 135 for two characters are stored in the storage means 130, as illustrated in FIG. 21.

Next, in Step S4, the control means 24d judges whether or not input is terminated. If input is terminated, the process proceeds to Step S91. If input is not terminated, the process returns to Step S11. It is assumed that input is terminated and the process proceeds to Step S91.

In Step S91, the control means 24d controls the storage means 130 to output the top-ranked candidate character of a character recognition result stored in the storage means 130 in the same time sequence as it is stored in the storage means 130 to the connection section 3. In this step, the top-ranked candidate character 138 (Katakana character “a”) of the character recognition result 133 shown in FIG. 21 is outputted.

Then, in Step S3, the control means 24b gives an instruction to the connection section 3, and the connection section 3 sends the character outputted from the storage means 130 to the portable telephone 10. In this preferred embodiment, the character information about the top-ranked candidate character 138 (Katakana character “a”) is sent to the portable telephone 10, and the top-ranked candidate character 138 (Katakana character “a”) appears on the display screen 11, as shown in FIG. 22.

In Step S92, the control means 24d checks whether the top-ranked candidate characters of all character recognition results stored in the storage means 130 have been sent. If they are all sent, the process is terminated; otherwise, the process returns to Step S91. In this example, not all characters have been sent, and the process returns to Step S91.

In Step S91, the control means 24d controls the storage means 130 to output the top-ranked candidate character of a character recognition result stored in the storage means 130 in the same time sequence as it is stored in the storage means 130 to the connection section 3. In this step, the top-ranked candidate character 139 (Katakana character “me”) of the character recognition result 135 shown in FIG. 21 is outputted.

Then, in Step S3, the control means 24b gives an instruction to the connection section 3, and the connection section 3 sends the character outputted from the storage means 130 to the portable telephone 10. In this preferred embodiment, the top-ranked candidate character 139 (Katakana character “me”) is sent to the portable telephone 10, and appears adjacent to the top-ranked candidate character 138 (Katakana character “a”) on the display screen 11, as shown in FIG. 23.

In Step S92, the control means 24d checks whether the top-ranked candidate characters of all character recognition results stored in the storage means 130 have been sent. If they are all sent, the process is terminated; otherwise, the process returns to Step S91. In this example, all characters have been sent, and the process is terminated.

Thus, the fourth preferred embodiment is adapted to send the top-ranked candidate characters included in the character recognition results on a character-by-character basis. However, if the portable telephone is capable of holding all of the candidate characters included in the character recognition result, all of the candidate characters may be sent as a single unit of sending information to the portable telephone. This is advantageous in allowing the user to select among the candidate characters on the portable telephone 10.

Although the character recognition results are illustrated as including only Kana characters in the fourth preferred embodiment, other character codes such as Kanji characters may be sent as a result of character recognition directly to the portable telephone.

Further, the character recognition result is sent to the portable telephone as soon as the character input is terminated in the fourth preferred embodiment. However, the character recognition result stored in the storage means 130 may be sent to the portable telephone at the time when an external device such as the portable telephone is connected to the auxiliary input device or at the time when the transfer button 15 is pressed.

Although the character recognition results stored in the storage means 130 are sent sequentially in succession to the portable telephone, one character may be sent each time the transfer button 15 is pressed.

Indications including status lamp illumination, sound output and the like may be provided to inform the user about the end of recognition of one character if the auxiliary input device is used without being connected to the external device such as the portable telephone.

As described above, the auxiliary input device according to the fourth preferred embodiment comprises the storage means for storing the character recognition results therein. This allows the auxiliary input device alone to store the character information in the storage means 130, to improve the usability. Additionally, the user need not verify the character recognition result for each character on the screen of the portable telephone or the external device, but may continuously perform the writing operation, whereby the usability is improved.

Further, the auxiliary input device may be used without being connected to the external device such as the portable telephone. This improve the portability without degradation in usability.

Moreover, the auxiliary input device according to the fourth preferred embodiment can input characters by handwriting, thereby to enable nonusers of PCs to easily enter characters.

Fifth Preferred Embodiment

FIG. 24 is a block diagram of the auxiliary input device according to a fifth preferred embodiment of the present invention. As shown in FIG. 24, the auxiliary input device according to the fifth preferred embodiment comprises the input section 20, a character recognition means 61a, a candidate character rearrangement means 62, the key code generation means 2, the connection section 3, a writing medium determination means 60, a correction means 63a, a keying means 23a, and a control means 24e.

The writing medium determination means 60 determines whether a character is written with a fingernail tip, a pen or the like or with the ball of a finger, based on pressure distribution information near a coordinate point obtained by the input section 20. The character recognition means 61a converts a character pattern into a single-stroke character pattern so as to absorb variations such as a gap or break between strokes and a running hand, to perform character recognition.

The candidate character rearrangement means 62 rearranges candidate characters of a character recognition result obtained from the character recognition means 61a, based on the result of determination of the writing medium determination means 60. The correction means 63a corrects errors, if any, in the recognition result to provide a correct character using the candidate characters of the recognition result. The keying means 23a refers to a keyboard disclosed in, for example, Japanese Patent Application Laid-Open No. 2001-159946, and the like. The control means 24e controls the sections and means 20, 61a, 62, 2, 3, 60, 63a and 23a. The remaining structure of the fifth preferred embodiment is similar to that of the third preferred embodiment shown in FIG. 12, and is not particularly described.

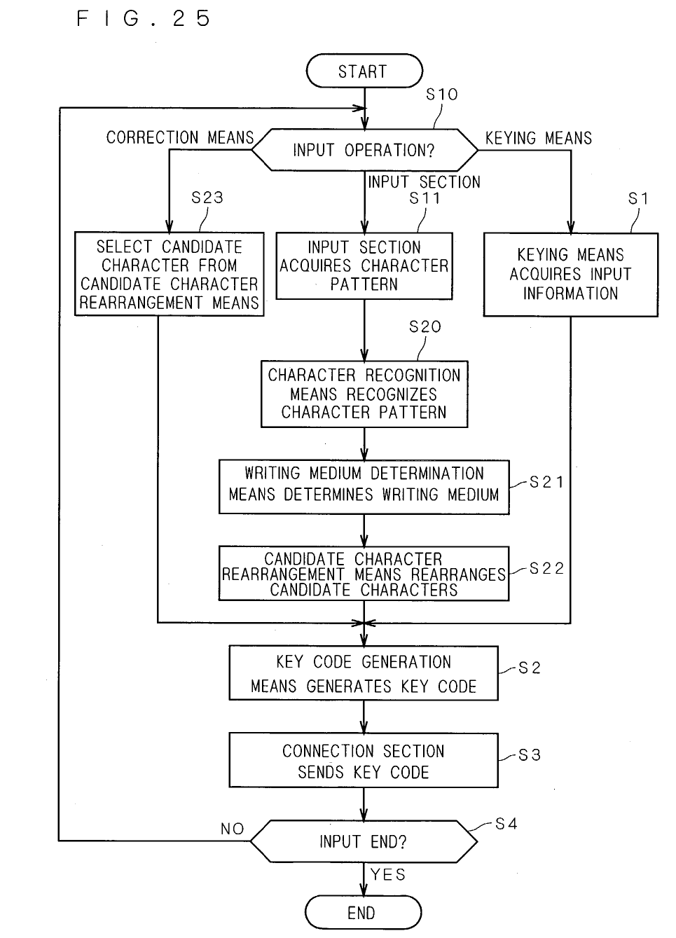

FIG. 25 is a flowchart showing the procedure of a handwriting input operation using the auxiliary input device according to the fifth preferred embodiment. This process is performed under the control of the control means 24e. The precondition of the fifth preferred embodiment is identical with that of the first to fourth preferred embodiments.

FIG. 26 illustrates a character handwritten on the input section 20 with a fingernail tip. As shown in FIG. 26, the handwritten character 67 (Hiragana character “ko”) is written on the input section 20.

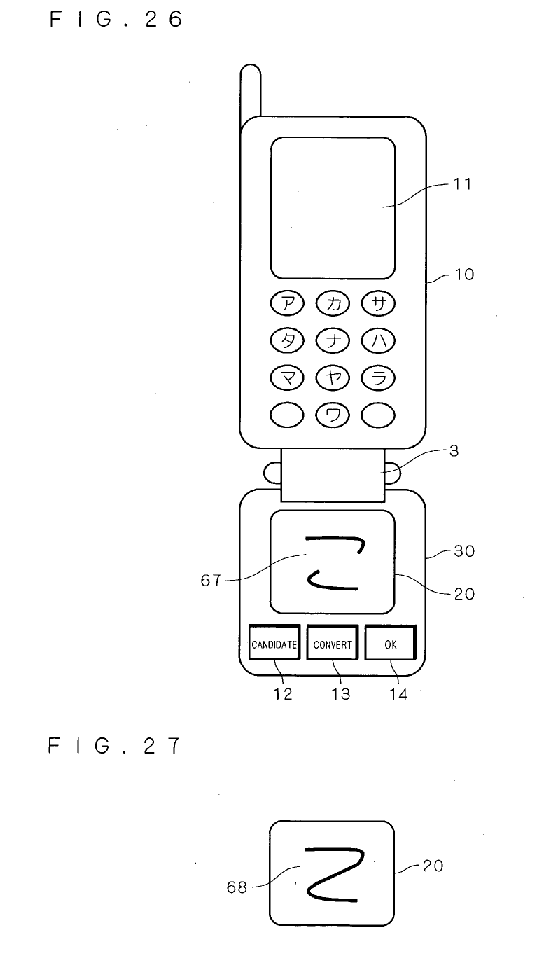

FIG. 27 shows an input pattern whose strokes are connected together by the character recognition means 61a. As shown in FIG. 27, a character pattern 68 after the strokes thereof are connected together is recognized.

FIG. 28 illustrates candidate characters of a character recognition result obtained by the character recognition means 61a recognizing the character pattern written on the input section 20. As illustrated in FIG. 28, candidate characters, e.g. a top-ranked candidate character 33 (Hiragana character “te”) and a second-ranked candidate character 34 (Hiragana character “ko”), are recognized.

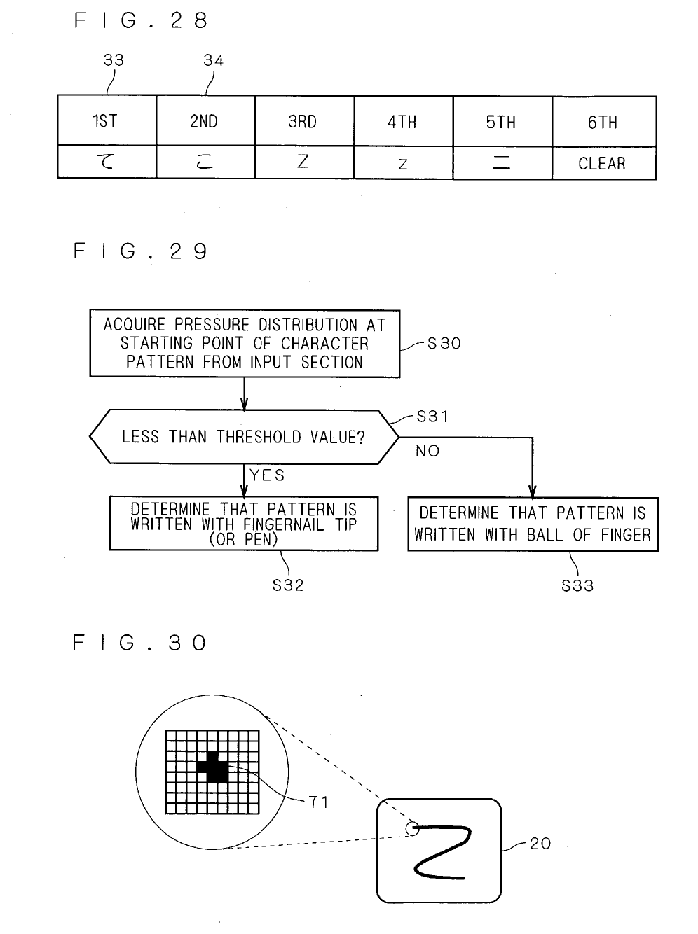

FIG. 29 is a flowchart showing a flow of the determination process of the writing medium determination means 60.

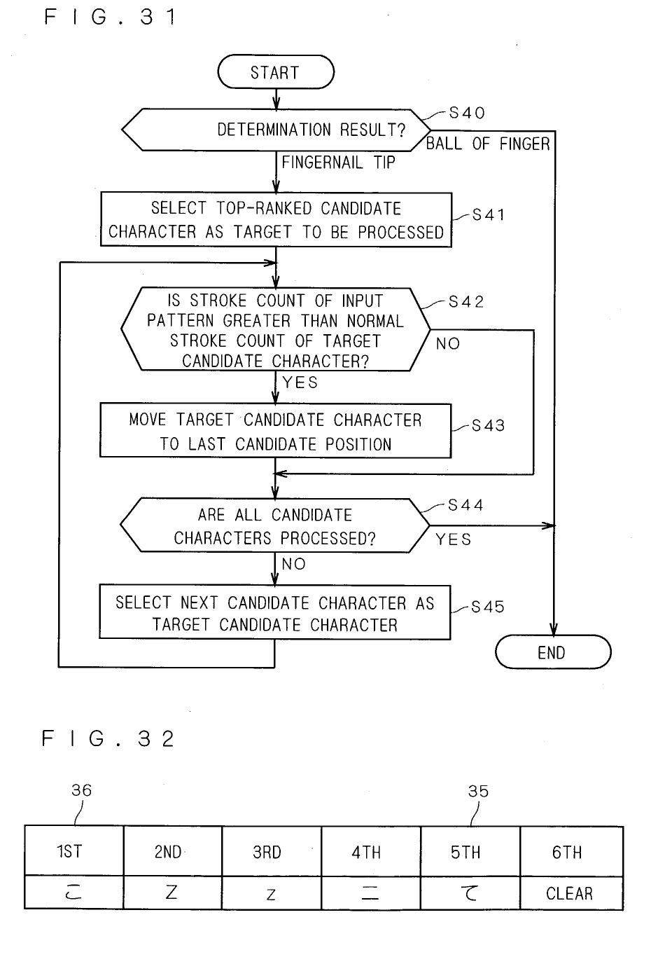

FIG. 30 illustrates how the writing medium determination means 60 determines the writing medium based on the character pattern. Referring to FIG. 30, the determination is made based on a pressure distribution 71 detected by the input section 20 at the starting point of the character pattern.

FIG. 31 is a flowchart showing a flow of the process of the candidate character rearrangement means 62.

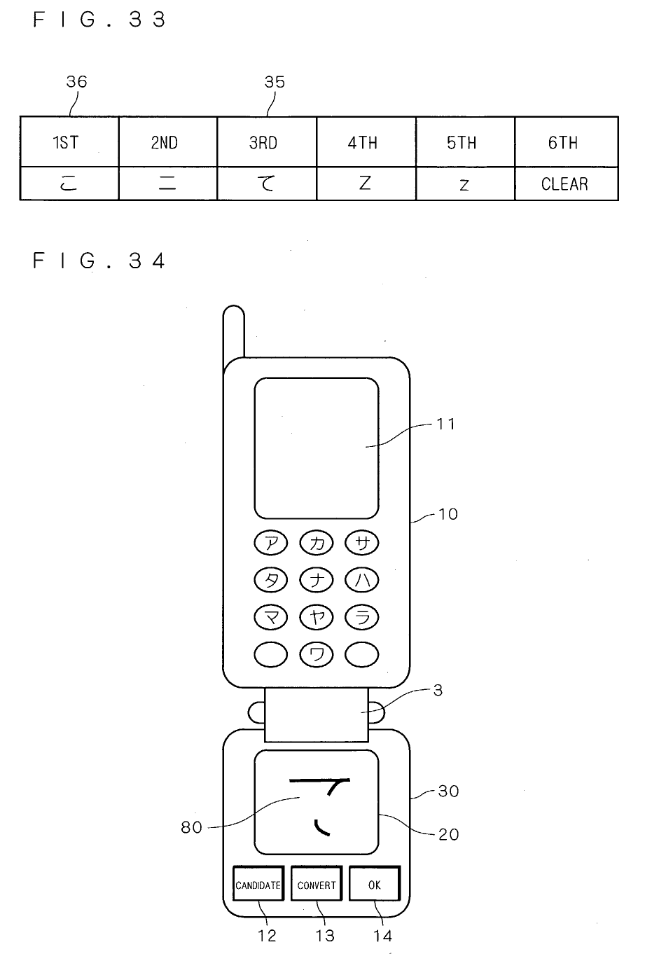

FIG. 32 illustrates a recognition result after the candidate character rearrangement means 62 performs the rearrangement process upon a previous top-ranked candidate character 35 (Hiragana character “te”) of the recognition result.

FIG. 33 illustrates a character recognition result after the candidate character rearrangement means 62 performs the rearrangement process upon all of the candidate characters.

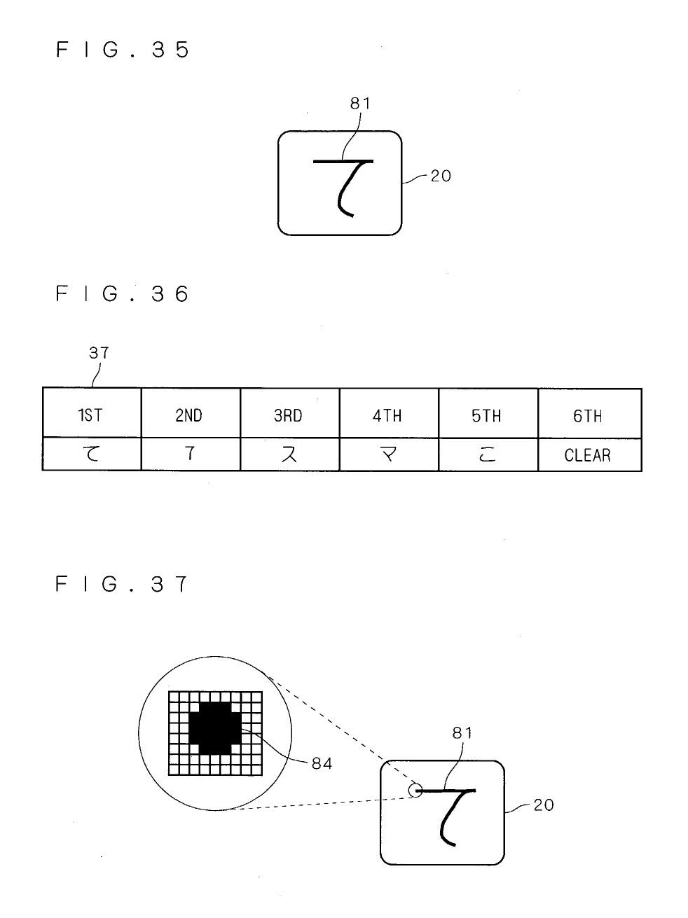

FIG. 34 illustrates a character pattern 80 (Hiragana character “te”) written on the input section 20 using the ball of a finger as the writing medium.

FIG. 35 shows a character pattern whose strokes are connected together by the character recognition means 61a. As shown in FIG. 35, a character pattern 81 after the strokes thereof are connected together is recognized.

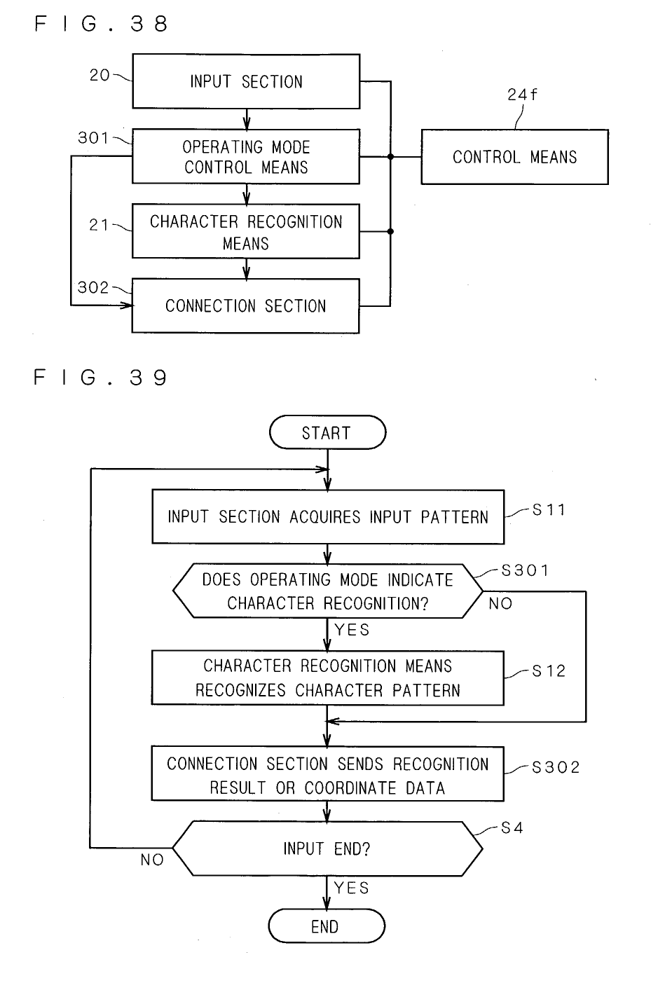

FIG. 36 illustrates a character recognition result in tabular form which is obtained by the character recognition means 61a recognizing the character pattern 81 written on the input section 20. As illustrated in FIG. 36, candidate characters, e.g. a top-ranked candidate character 37 (Hiragana character “te”), are recognized.

The operation of the fifth preferred embodiment will be described with reference to the flowchart of FIG. 25. First, in Step S10, the control means 24e examines which means was used for input operation. If the correction means 63a was used, the process proceeds to Step S23. If the input section 20 was used, the process proceeds to Step S11. If the keying means 23a is used, the process proceeds to Step S1. It is assumed in this preferred embodiment that a character is handwritten on the input section 20 with a fingernail tip and the process proceeds to Step S11.

In Step S11, the control means 24e controls the input section 20 to acquire a character pattern. It is assumed that the character pattern of the handwritten character 67 shown in FIG. 26 is acquired.

Next, in Step S20, the control means 24e sends the input pattern obtained by the input section 20 to the character recognition means 61a, and the character recognition means 61a converts the input pattern into a single-stroke character pattern by an existing method to recognize the character. The character pattern 68 shown in FIG. 27 is the single-stroke character pattern, and candidate characters of the obtained character recognition result are shown in FIG. 28. In this preferred embodiment, since the single-stroke character pattern resembles the Hiragana character “te,” the top-ranked candidate character 33 (Hiragana character “te”) of the character recognition result is not a correct character intended by the user, but the correct character is the second-ranked candidate character 34 (Hiragana character “ko”).

Next, in Step S21, the control means 24e controls the writing medium determination means 60, and the writing medium determination means 60 determines the writing medium with which the character pattern is written on the input section 20. The operation of the writing medium determination means 60 will be described with reference to the process flow shown in FIG. 29.

Referring to FIG. 29, the writing medium determination means 60 gives an instruction to the input section 20 to acquire a pressure distribution at the starting point of the character pattern, in Step S30. The pressure distribution 71 at the starting point of the character pattern 67 (Hiragana character “ko”) is obtained, as shown in FIG. 30. Since the character pattern 67 is written with a fingernail tip, the pressure distribution has a small area. (Solid squares in FIG. 30 denote the area in which a pressure not less than a predetermined value is detected.)

Then, in Step S31, the writing medium determination means 60 determines whether or not the area of the pressure distribution is less than a constant threshold value. Assuming that the threshold value is “9” (the number of pressure-detected squares), the area of the pressure distribution 71 is “6” which is less than the threshold value. The answer to the determination in Step S31 is then “YES,” and the process proceeds to Step S32.

In Step S32, it is determined that the current input pattern is written with a fingernail tip (or a pen).

Thereafter, the process returns to Step S22 in the process flow of the control means 24e. The control means 24e gives an instruction to the candidate character rearrangement means 62 to rearrange the candidate characters of the character recognition result obtained by the character recognition means 61a based on the result of determination of the writing medium determination means 60. The operation of the candidate character rearrangement means 62 will be described using the process flow of the candidate character rearrangement means 62 shown in FIG. 31.

With reference to FIG. 31, the candidate character rearrangement means 62 checks the result of determination obtained by the writing medium determination means 60. If a fingernail tip was used for writing, the process proceeds to step S41. If the ball of a finger was used for writing, the process is terminated without performing the candidate character rearrangement process. In this example, the result of determination is the “fingernail tip” and the process proceeds to Step S41.

In Step S41, the leading candidate character is selected as a target to be processed. In this example, the top-ranked candidate character 33 (Hiragana character “te”) shown in FIG. 28 is selected as a target candidate character.

Next, in Step S42, a comparison is made between the stroke count (or the number of strokes) of the character pattern and a normal stroke count (i.e., a stroke count when a character is written in the standard (printed) style) of the target candidate character. If the stroke count of the input pattern is greater than the normal stroke count of the target candidate character, the answer is “YES” and the process proceeds to Step S43. If the stroke count of the input pattern is equal to or less than the normal stroke count of the target candidate character, the answer is “NO” and the process proceeds to Step S44. In this example, the input pattern is written with two strokes, whereas the normal stroke count of the target candidate character (Hiragana character “te”) is one. Thus, the answer is “YES” and the process proceeds to Step S43.

In Step S43, the target candidate character is moved to the last (bottom-ranked) candidate position. In this example, since no candidate character is placed in the sixth rank, the previous top-ranked candidate character (Hiragana character “te”) is moved down to the fifth rank. The second- to fifth-ranked candidate characters prior to the candidate rearrangement are moved up to the top (or first) to fourth ranks, respectively.

Next, in Step S44, a determination is made as to whether or not all candidate characters have been processed. If so, the answer is “YES” and the rearrangement process is terminated; if not, the answer is “NO” and the process proceeds to Step S45. In this example, since not all candidate characters have been yet processed, the answer is “NO” and the process proceeds to Step S45.

In Step S45, the next candidate character is selected as the target candidate character. In this example, the previous second-ranked candidate character 36 (Hiragana character “ko”) shown in FIG. 32 is selected as the target candidate character.

Then, in Step S42, a comparison is made between the stroke count of the character pattern and a normal stroke count of the target candidate character. If the stroke count of the input pattern is greater than the normal stroke count of the target candidate character, the answer is “YES” and the process proceeds to Step S43. If the stroke count of the input pattern is equal to or less than the normal stroke count of the target candidate character, the answer is “NO” and the process proceeds to Step S44. In this example, the input pattern is written with two strokes, whereas the normal stroke count of the target candidate character (Hiragana character “ko”) is two. Thus, the answer is “NO” and the process proceeds to Step S44.

In Step S44, a determination is made as to whether or not all candidate characters have been processed. If so, the answer is “YES” and the rearrangement process is terminated; if not, the answer is “NO” and the process proceeds to Step S45. In this example, since not all candidate characters have been yet processed, the answer is “NO” and the process proceeds to Step S45. Subsequently, similar processes are performed, and the candidate characters shown in FIG. 33 are finally obtained. Specifically, the previous second-ranked candidate character 36 (Hiragana character “ko”) is moved to the top rank, and the correct recognition result is obtained.

Next, the process returns to Step S2 in the process flow of the control means 24e. Subsequent processes are similar to those of the first preferred embodiment. The previous second-ranked candidate character (Hiragana character “ko”) is sent as the sending information to the portable telephone.

The operation of the fifth preferred embodiment when a character is written with the ball of a finger will be described with reference to the flowchart of FIG. 25. First, in Step S10, the control means 24e examines which means was used for input operation. If the correction means 63a was used, the process proceeds to Step S23. If the input section 20 was used, the process proceeds to Step S11. If the keying means 23a is used, the process proceeds to Step S1. It is assumed in this preferred embodiment that a character is handwritten on the input section 20 with the ball of a finger and the process proceeds to Step S11.

In Step S11, the control means 24e controls the input section 20 to acquire a character pattern. It is assumed that the character pattern 80 shown in FIG. 34 is acquired. The input pattern of the Hiragana character “te” written with the ball of a finger has a partial discontinuity.

Next, in Step S20, the control means 24e sends the input pattern obtained by the input section 20 to the character recognition means 61a, and the character recognition means 61a converts the input pattern into a single-stroke character pattern by an existing method to recognize the character. The character pattern 81 shown in FIG. 35 is the single-stroke pattern into which the character pattern 80 of FIG. 34 is converted, and candidate characters of the obtained character recognition result are shown in FIG. 36. In this preferred embodiment, the discontinuity in the character pattern is compensated and filled after the conversion, and the pattern of the Hiragana character “te” is reproduced. Thus, the top-ranked candidate character 37 of the recognition result is the correct Hiragana character “te.” Next, in Step S21, the control means 24e controls the writing medium determination means 60 to determine the writing medium with which the character pattern is written on the input section 20, as in the case of writing with the fingernail tip. The operation of the writing medium determination means 60 will be described with reference to the process flow shown in FIG. 29.

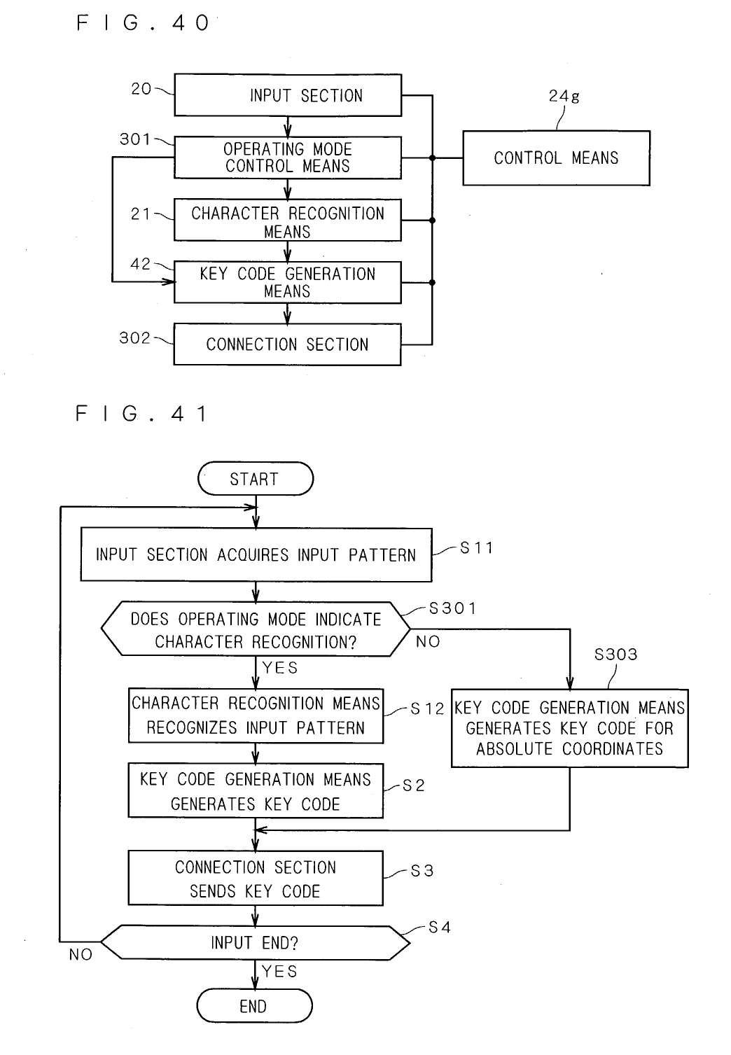

Referring to FIG. 29, the writing medium determination means 60 gives an instruction to the input section 20 to acquire a pressure distribution at the starting point of the character pattern, in Step S30. FIG. 37 illustrates a pressure distribution 84 at the starting point of the character pattern 81 (Hiragana character “te”). As shown in FIG. 37, since the character pattern is written with the ball of a finger, the pressure distribution 84 has a large area. (Solid squares in FIG. 37 denote the area in which a pressure is detected.)

Then, in Step S31, the writing medium determination means 60 determines whether or not the area of the pressure distribution is less than the constant threshold value. Assuming that the threshold value is “9” (the number of pressure-detected squares), the area of the pressure distribution 84 is “21” which is not less than the threshold value. The answer to the determination in Step S31 is then “NO,” and the process proceeds to Step S33.

In Step S33, it is determined that the current input pattern is written with the ball of a finger.

Thereafter, the process returns to Step S22 in the process flow of the control means 24e shown in FIG. 25. The control means 24e controls the candidate character rearrangement means 62 to rearrange the candidate characters of the character recognition result obtained by the character recognition means 61a based on the result of determination of the writing medium determination means 60. The operation of the candidate character rearrangement means 62 will be described using the process flow of the candidate character rearrangement means 62 shown in FIG. 31.

With reference to FIG. 31, in Step S40, the candidate character rearrangement means 62 checks the result of determination obtained by the writing medium determination means 60. If a fingernail tip was used for writing, the process proceeds to step S41. If the ball of a finger was used for writing, the process is terminated without performing the candidate character rearrangement process. In this example, the result of determination is the “ball of a finger” and the process is terminated without the rearrangement process.

Next, the process returns to Step S2 in the process flow of the control means 24e shown in FIG. 25. Subsequent processes are similar to those of the first or third preferred embodiment. The character information about the top-ranked candidate character 37 (Hiragana character “te”) shown in FIG. 36 is sent to the portable telephone 10.

The correction operation of the correction means 63a when the character recognition result is incorrect in the process flow of the control means 24e shown in FIG. 25 is slightly different from that of the second preferred embodiment. The difference is only whether the correction means 63a acquires the candidate character of the character recognition result from the character recognition means 21 or from the candidate character rearrangement means 62. Detailed description of the correction operation of the correction means 63a will be omitted herein. The operation of the keying means 23a is similar to an existing keyboard entry and the like.

The pressure distribution on the input section 20 is used to determine the writing medium by the writing medium determination means 60 in the fifth preferred embodiment. However, the writing medium may be determined by comparing the magnitude of the pressure value itself at the coordinate point with a threshold value.

Although the pressure distribution at the starting point of the character pattern is used to determine the writing medium by the writing medium determination means 60 in the fifth preferred embodiment, coordinate points other than the starting point may be used. Further, a maximum writing pressure value or a pressure distribution at one of the coordinate points which has the greatest writing pressure value may be used.

Although the pressure distribution at the starting point of the character pattern is used to determine the writing medium by the writing medium determination means 60 in the fifth preferred embodiment, an average writing pressure value or an average pressure distribution of all coordinate points may be used.

In this preferred embodiment, the candidate character rearrangement means 62 rearranges the candidate characters of the character recognition result, depending on the result of determination of the writing medium determination means 60. However, the result of determination may be sent to the character recognition means 61a which in turn limits the characters to be recognized to those having a fixed stroke count or greater, depending on the result of determination when the character recognition is performed.

In this preferred embodiment, the candidate character rearrangement means 62 rearranges the candidate characters of the character recognition result, depending on the result of determination of the writing medium determination means 60. However, the auxiliary input device may comprise a normal character recognition means, and another character recognition means for discontinuous characters (characters having a partial discontinuity) and characters written in a running hand, to suitably select between the two character recognition means depending on the result of determination.

As described above, the auxiliary input device according to the fifth preferred embodiment comprises the writing medium determination means 60, and is adapted to output the recognition result depending on the result of determination. This provides optimum character recognition results in the cases where a pen or a fingernail tip was used for writing and where the ball of a finger was used for writing, thereby to provide the auxiliary input device capable of high-accuracy handwriting input.

Sixth Preferred Embodiment

FIG. 38 is a block diagram of the auxiliary input device according to a sixth preferred embodiment of the present invention. As shown in FIG. 38, the auxiliary input device according to the sixth preferred embodiment comprises the input section 20, an operating mode control means 301, the character recognition means 21, a connection section 302, and a control means 24f.

The operating mode control means 301 determines whether or not to perform a character recognition process. The connection section 302 sends character information and a character pattern to an external device. The control means 24f controls the input section 20, the operating mode control means 301, the character recognition means 21, and the connection section 302. The remaining structure of the sixth preferred embodiment is similar to that of the first preferred embodiment shown in FIG. 1.

FIG. 39 is a flowchart showing the procedure of a handwriting input operation using the auxiliary input device according to the sixth preferred embodiment. This process is performed under the control of the control means 24f. The precondition of the sixth preferred embodiment is identical with that of the first to fifth preferred embodiments.

The operation of the sixth preferred embodiment will be described with reference to the flowchart of FIG. 39. First, in Step S11, the control means 24f controls the input section 20 to acquire an input pattern including a character pattern.

Next, in Step S301, the control means 24f inquires of the operating mode control means 301 as to the current operating mode. If the operating mode indicates the character recognition, the process proceeds to Step S12 for the subsequent processes similar to those of the first preferred embodiment. If not, the process proceeds to Step S302. In this example, the operating mode which indicates no character recognition will be described.

If the operating mode indicates no character recognition, the process proceeds to Step S302 in which the control means 24f sends coordinate data which is the input pattern obtained from the input section 20 to the connection section 302, and the connection section 302 sends the coordinate data to the external device such as the portable telephone 10.

Next, in Step S4, the control means 24f judges whether or not input is terminated. If input is not terminated, the process returns to Step S11. If input is terminated, the process is terminated.

As described above, the auxiliary input device according to the sixth preferred embodiment comprises the operating mode control means 301, to enable the input pattern (writing information) from the input section 20 to be directly sent as the coordinate data to the external device without the character recognition of the input pattern. This allows the implementation of an application which uses the writing information itself in the external device, thereby to provide the auxiliary input device which extends the functionality of the external device.

Seventh Preferred Embodiment

FIG. 40 is a block diagram of the auxiliary input device according to a seventh preferred embodiment of the present invention. As shown in FIG. 40, the auxiliary input device according to the seventh preferred embodiment comprises the input section 20, the operating mode control means 301, the character recognition means 21, a key code generation means 42, the connection section 302, and a control means 24g.

The key code generation means 42 generates a key code corresponding to a character code obtained from the character recognition means 21, and generates a key code corresponding to absolute coordinates from an input pattern (coordinate data) obtained from the input section 20. The control means 24g controls the input section 20, the operating mode control means 301, the character recognition means 21, the key code generation means 42, and the connection section 302. The remaining structure of the seventh preferred embodiment is similar to that of the sixth preferred embodiment shown in FIG. 38.

FIG. 41 is a flowchart showing the procedure of a handwriting input operation using the auxiliary input device according to the seventh preferred embodiment. This process is performed under the control of the control means 24g. The precondition of the seventh preferred embodiment is identical with that of the first to sixth preferred embodiments.

FIG. 42 is a view illustrating coordinate axes in the input section 20. As shown in FIG. 42, the origin 305 of the input area of the input section 20 is established in the upper left portion of the figure, and an X coordinate axis 306 and a Y coordinate axis 308 are defined to extend respectively rightwardly and downwardly, as viewed in FIG. 42, from the origin 305. A maximum X value Xmax and a maximum Y value Ymax are also defined.

The operation of the seventh preferred embodiment will be described with reference to the flowchart of FIG. 41.

First, in Step S11, the control means 24g controls the input section 20 to acquire an input pattern.

Next, in Step S301, the control means 24g inquires of the operating mode control means 301 as to the current operating mode. If the operating mode indicates the character recognition, the process proceeds to Step S12. If not, the process proceeds to Step S303. In this example, the operating mode which indicates the character recognition will be first described.

If the operating mode indicates the character recognition, the process proceeds to Step S12 in which the control means 24g sends the input pattern obtained by the input section 20 to the character recognition means 21, and the character recognition means 21 outputs a character recognition result.

Next, in Step S2, the control means 24g sends character information about the top-ranked candidate character included in the character recognition result obtained by the character recognition means 21 to the key code generation means 42, and the key code generation means 2 generates a corresponding key code for the external device from the character information.

Next, in Step S3, the control means 24g sends the key code generated by the key code generation means 42 to the connection section 302, and the connection section 302 sends the key code to the external device.

Next, in Step S4, the control means 24g judges whether or not input is terminated. In this example, it is assumed that input is terminated and the process is terminated.

The operation will then be described when the operating mode indicates no character recognition in Step S301. Then, the process proceeds to Step S303.

In Step S303, the control means 24g sends the input pattern (coordinate data) obtained by the input section 20 as it is to the key code generation means 42. The key code generation means 42 converts all pairs of absolute coordinates on which the contact of the writing medium with the input section 20 is detected into respectively corresponding key codes. The absolute coordinates to be converted by the key code generation means 42 are based on the assumption that the origin (0, 0) is at the upper left corner and the X and Y axes extend rightwardly and downwardly from the origin as shown in FIG. 42. The key code generation means 42 converts coordinate points having respective pairs of absolute coordinates into corresponding key codes.

Next, in Step S3, the control means 24g sends all of the key codes corresponding to the respective pairs of absolute coordinates converted by the key code generation means 42 to the connection section 302. The connection section 302 sequentially sends the key codes to the external device.

Next, in Step S4, the control means 24g judges whether or not input is terminated. In this example, it is assumed that input is terminated and the process is terminated.

As described above, the auxiliary input device according to the seventh preferred embodiment comprises the key code generation means 42 for converting the input data from the input section into the key code corresponding to a pair of absolute coordinates. This allows the implementation of an application (e.g., position control on a menu screen) which uses the absolute coordinate data in the external device, thereby to improve the applicability of the auxiliary input device.

Eighth Preferred Embodiment

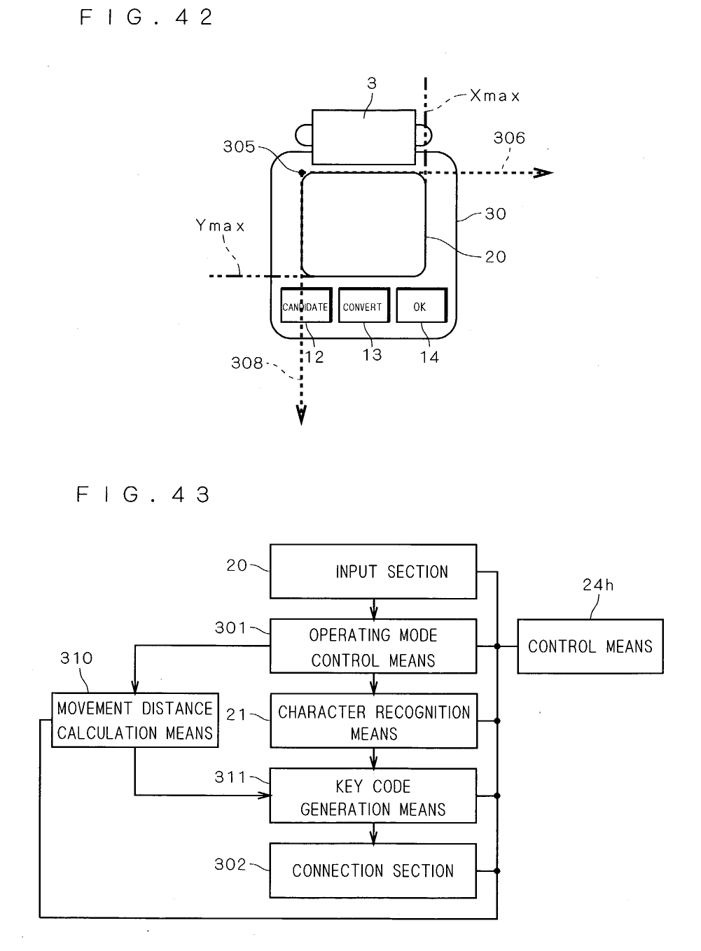

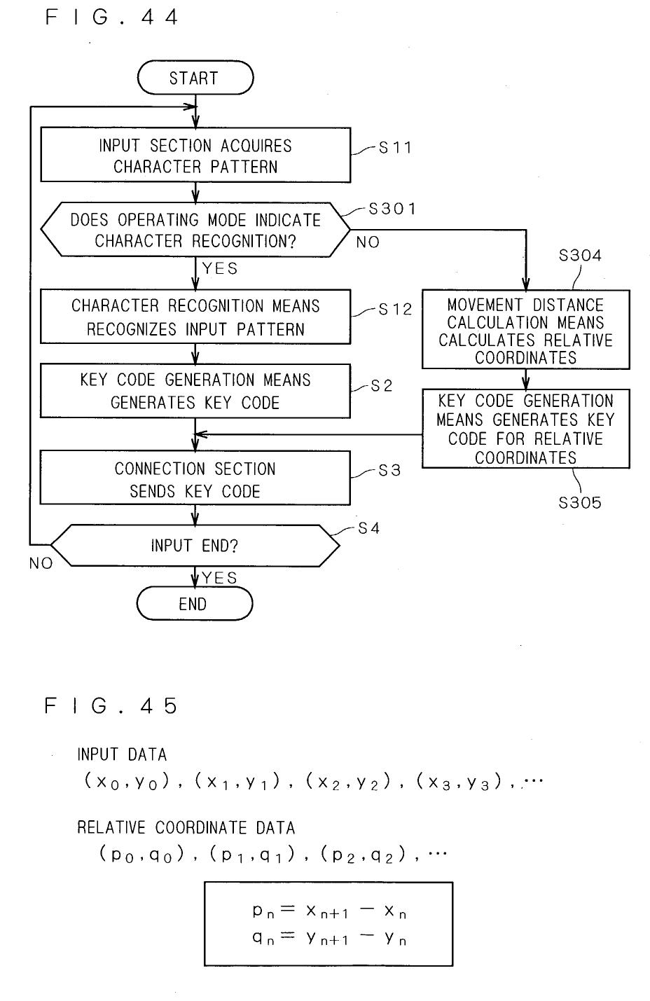

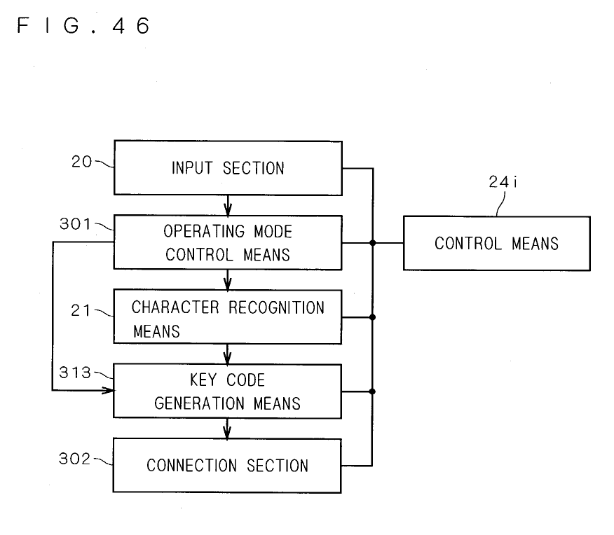

FIG. 43 is a block diagram of the auxiliary input device according to an eighth preferred embodiment of the present invention. As shown in FIG. 43, the auxiliary input device according to the eighth preferred embodiment comprises the input section 20, the operating mode control means 301, the character recognition means 21, a key code generation means 311, the connection section 302, a movement distance calculation means 310, and a control means 24h.

The movement distance calculation means 310 calculates a distance of movement from the input pattern (coordinate data) obtained from the input section 20 to generate relative coordinate data. The key code generation means 311 generates a key code corresponding to character information, and generates a key code corresponding to the relative coordinate data obtained from the movement distance calculation means 310. The control means 24h controls the input section 20, the operating mode control means 301, the character recognition means 21, the key code generation means 311, the connection section 302, and the movement distance calculation means 310. The remaining structure of the eighth preferred embodiment is similar to that of the sixth preferred embodiment shown in FIG. 38.

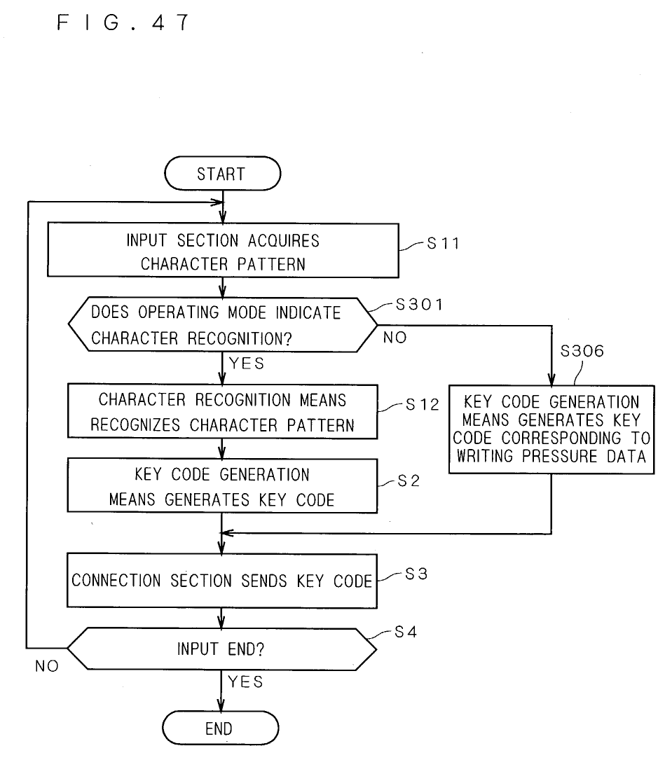

FIG. 44 is a flowchart showing the procedure of a handwriting input operation using the auxiliary input device according to the eighth preferred embodiment. This process is performed under the control of the control means 24h. The precondition of the eighth preferred embodiment is identical with that of the first to seventh preferred embodiments.

FIG. 45 illustrates an example of generation of the relative coordinate data from the coordinate data about the input pattern. As shown in FIG. 45, upon detection of absolute coordinate data about the input pattern written in the following order (or writing direction): (x₀, y₀), (x₁, y₁), (x₂, y₂) and (X₃, y₃), the movement distance calculation means 310 calculates relative coordinate data (p₀, q₀), (p₁, q₁), and (p₂, q₂). In this process, pₙ and qₙ (n=0 to 2) are calculated as pₙ=xₙ₊₁−xₙ and qₙ=yₙ₊₁−yₙ, respectively.

The operation of the eighth preferred embodiment will be described with reference to the flowchart of FIG. 44. First, in Step S11, the control means 24h controls the input section 20 to acquire an input pattern.

Next, in Step S301, the control means 24h inquires of the operating mode control means 301 as to the current operating mode. If the operating mode indicates the character recognition, the process proceeds to Step S12 for the subsequent processes similar to those of the seventh preferred embodiment. If not, the process proceeds to Step S304. In this example, the operating mode which indicates no character recognition will be described.

In Step S304, the control means 24h sends the input pattern obtained by the input section 20 to the movement distance calculation means 310, and the movement distance calculation means 310 calculates relative coordinates based on the absolute coordinates of the entire input pattern. The relative coordinates generated by the movement distance calculation means 310 are calculated, for example, in a manner described with reference to FIG. 45.

Next, in Step S305, the control means 24h sends all of the relative coordinates generated by the movement distance calculation means 310 to the key code generation means 311, and the key code generation means 311 generates key codes corresponding to all pairs of the relative coordinates.

Next, in Step S3, the control means 24h sends all of the key codes corresponding to the respective pairs of absolute coordinates generated by the key code generation means 42 to the connection section 302. The connection section 302 sends the key codes to the external device such as the portable telephone 10.

Next, in Step S4, the control means 24h judges whether or not input is terminated. In this example, it is assumed that input is terminated and the process is terminated.

As described above, the auxiliary input device according to the eighth preferred embodiment comprises the movement distance calculation means 310 for calculating the relative coordinates from the input pattern from the input section 20, and the key code generation means 311 for converting the relative coordinate pair into the corresponding key code. This allows the implementation of an application (e.g., mouse-like use) which uses the relative coordinate data in the external device, thereby to improve the applicability of the auxiliary input device.

The use of the relative coordinate data reduces the amount of information as compared with the absolute coordinate data, to allow accordingly efficient data transmission.

Ninth Preferred Embodiment

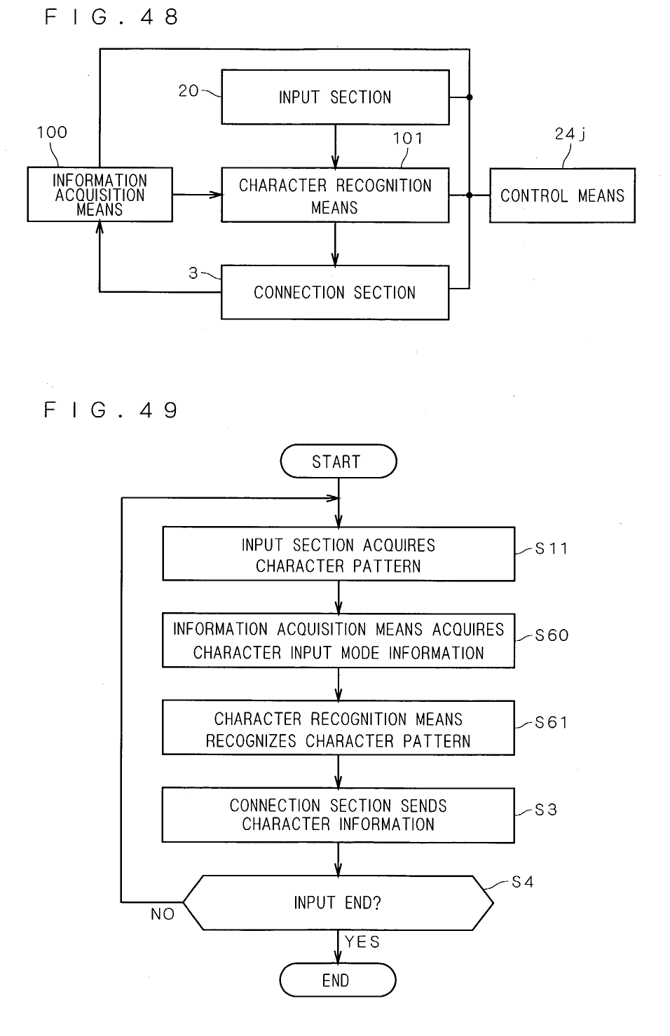

FIG. 46 is a block diagram of the auxiliary input device according to a ninth preferred embodiment of the present invention. As shown in FIG. 46, the auxiliary input device according to the ninth preferred embodiment comprises the input section 20, the operating mode control means 301, the character recognition means 21, a key code generation means 313, the connection section 302, and a control means 24i.

Referring to FIG. 46, the key code generation means 313 generates a key code provided for the external device from character information obtained from the character recognition means 21 and a character pattern obtained from the input section 20. The control means 24i controls the input section 20, the operating mode control means 301, the character recognition means 21, the key code generation means 313, and the connection section 302. The remaining structure of the ninth preferred embodiment is similar to that of the seventh preferred embodiment shown in FIG. 40.

FIG. 47 is a flowchart showing the procedure of a handwriting input operation using the auxiliary input device according to the ninth preferred embodiment. This process is performed under the control of the control means 24i. The precondition of the ninth preferred embodiment is identical with that of the first to eighth preferred embodiments.

The operation of the ninth preferred embodiment will be described with reference to the flowchart of FIG. 47.

Referring to FIG. 47, the control means 24i controls the input section 20 to acquire a character in Step S111.

Next, in Step S301, the control means 24i inquires of the operating mode control means 301 as to the current operating mode. If the operating mode indicates the character recognition, the process proceeds to Step S12 for the subsequent processes similar to those of the seventh preferred embodiment. If not, the process proceeds to Step S306. In this example, the operating mode which indicates no character recognition will be described.

If the operating mode indicates no character recognition, the control means 24i sends the character pattern (including writing pressure information) obtained by the input section 20 to the key code generation means 313 which in turn generates a key code corresponding to the writing pressure information, in Step S306. Examples of the writing pressure information include a pressure value at a predetermined coordinate point, a maximum writing pressure value, an average writing pressure value, a pressure distribution having pressure values exceeding a predetermined threshold value, and the like, as in the fifth preferred embodiment.

Next, in Step S3, the control means 24i sends the key code generated by the key code generation means 313 to the connection section 302, and the connection section 302 sends the key codes to the external device.

Next, in Step S4, the control means 24i judges whether or not input is terminated. In this example, it is assumed that input is terminated and the process is terminated.

As described above, the auxiliary input device according to the ninth preferred embodiment comprises the key code generation means 313 for converting the writing pressure information from the input section into the key code. This allows the implementation of an application (e.g., processing based on the magnitude of the writing pressure) which uses the writing pressure information in the external device, thereby to improve the applicability of the auxiliary input device.

Tenth Preferred Embodiment

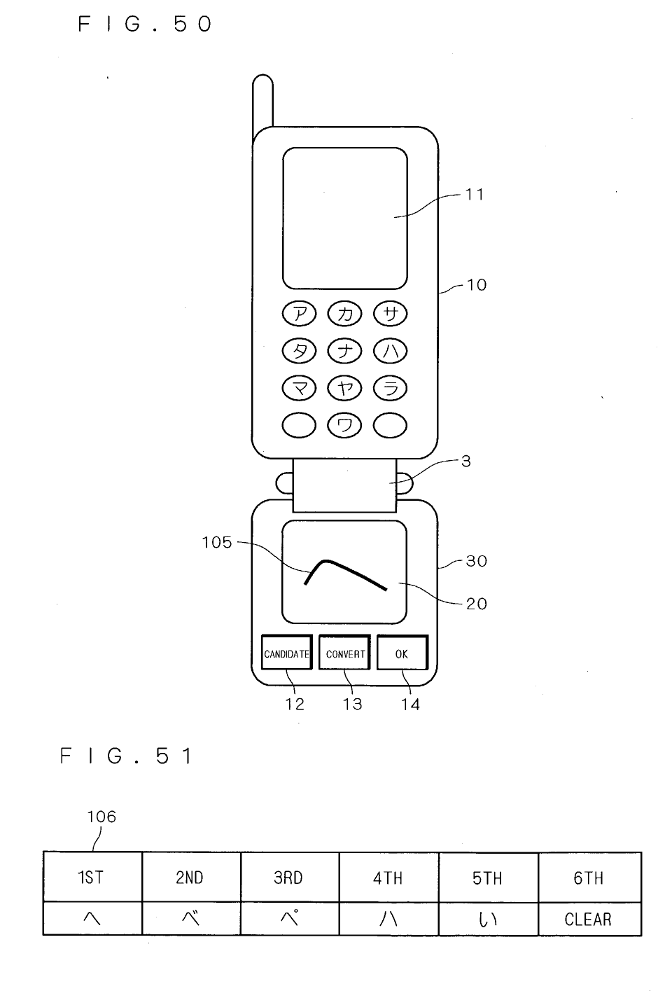

FIG. 48 is a block diagram of the auxiliary input device according to a tenth preferred embodiment of the present invention. As shown in FIG. 48, the auxiliary input device according to the tenth preferred embodiment comprises the input section 20, a character recognition means 101, the connection section 3, an information acquisition means 100, and a control means 24j.

Referring to FIG. 48, the (character type) information acquisition means 100 acquires character input mode information from the external device body. The character recognition means 101 narrows down or limits candidates based on the character input mode information (character type information) acquired by the information acquisition means 100 to perform character recognition. The control means 24j controls the input section 20, the character recognition means 101, the connection section 3, and the information acquisition means 100.

FIG. 49 is a flowchart showing the procedure of a handwriting input operation using the auxiliary input device according to the tenth preferred embodiment. This process is performed under the control of the control means 24j. The precondition of the tenth preferred embodiment is identical with that of the first to ninth preferred embodiments.

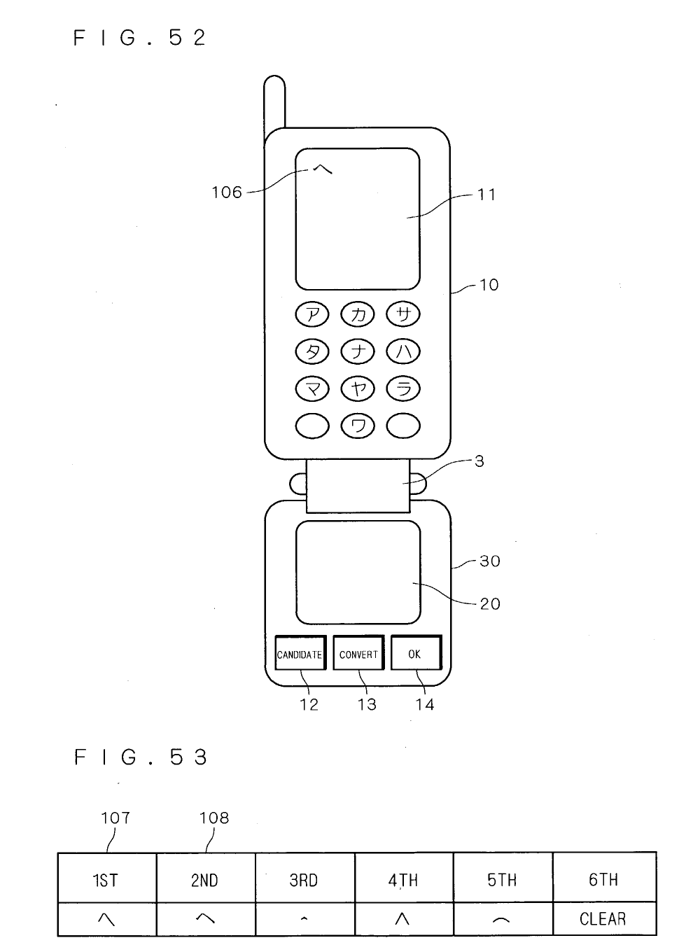

FIG. 50 illustrates a character 105 (Hiragana character “he”) handwritten on the input section 20.

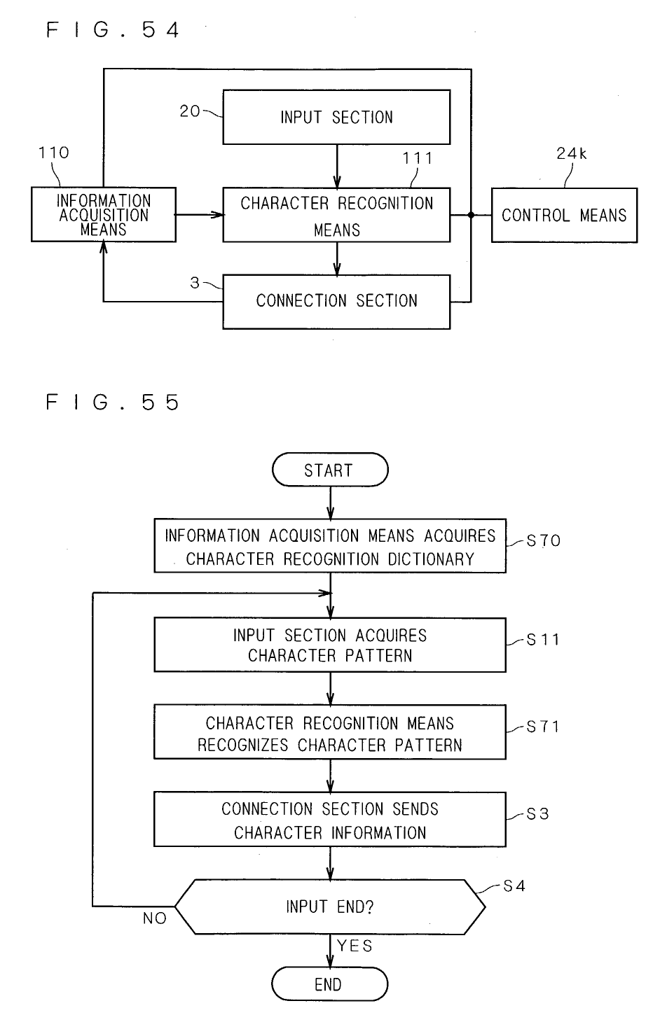

FIG. 51 illustrates candidate characters of a character recognition result recognized by the character recognition means 101. As illustrated in FIG. 51, candidate characters, e.g. a top-ranked candidate character 106 (Hiragana character “he”), are recognized.

FIG. 52 illustrates the top-ranked candidate character 106 (Hiragana character “he”) of the recognition result displayed on the display screen 11 of the portable telephone 10 through the connection section 3.

The operation of the tenth preferred embodiment will be described with reference to the flowchart of FIG. 49. First, in Step S11, the control means 24j controls the input section 20 to acquire a character pattern. It is assumed that the character pattern 105 indicating the Hiragana character “he” is acquired, as shown in FIG. 50.

Next, in Step S60, the control means 24j controls the information acquisition means 100 to acquire the character input mode information from the external device. The character input modes used herein refer to character types such as Hiragana, Katakana, Romaji, and Kanji modes. In this example, it is assumed that the character input mode information indicates Hiragana.

Then, in Step S61, the control means 24j sends the character pattern obtained by the input section 20 and the character input mode information obtained by the information acquisition means 100 to the character recognition means 101. The character recognition means 101 performs matching between the input pattern and a standard pattern corresponding to the acquired character input mode (Hiragana or Kanji) which is selected among standard patterns (or bit patterns for all characters) stored in the character recognition means 101, to output characters of a recognition result. In this preferred embodiment, it is assumed that a character recognition result for Hiragana and Kanji as shown in FIG. 51 is obtained.

Then, in Step S3, the control means 24j sends character information about the top-ranked candidate character 106 included in the character recognition result (See FIG. 51) obtained by the character recognition means 101 to the connection section 3, and the connection section 3 sends the character information to the portable telephone 10. In this preferred embodiment, the top-ranked candidate character 106 (Hiragana character “he”) is sent to the portable telephone 10, and is displayed on the display screen 11, as shown in FIG. 52.

Next, in Step S4, the control means 24j judges whether or not input is terminated. If input is not terminated, the process returns to Step S11. If input is terminated, the process is terminated.

In this preferred embodiment, the information acquisition means 100 acquires the character input mode information from the external device after the input to the input section 20 is terminated. However, the information acquisition means 100 may acquire the character input mode information before writing is done on the input section 20.

As described above, the auxiliary input device according to the tenth preferred embodiment comprises the information acquisition means 100, and is adapted to control the character recognition means 01 by using the character input mode information from the external device which is obtained by the information acquisition means 100. This achieves high-accuracy character recognition.

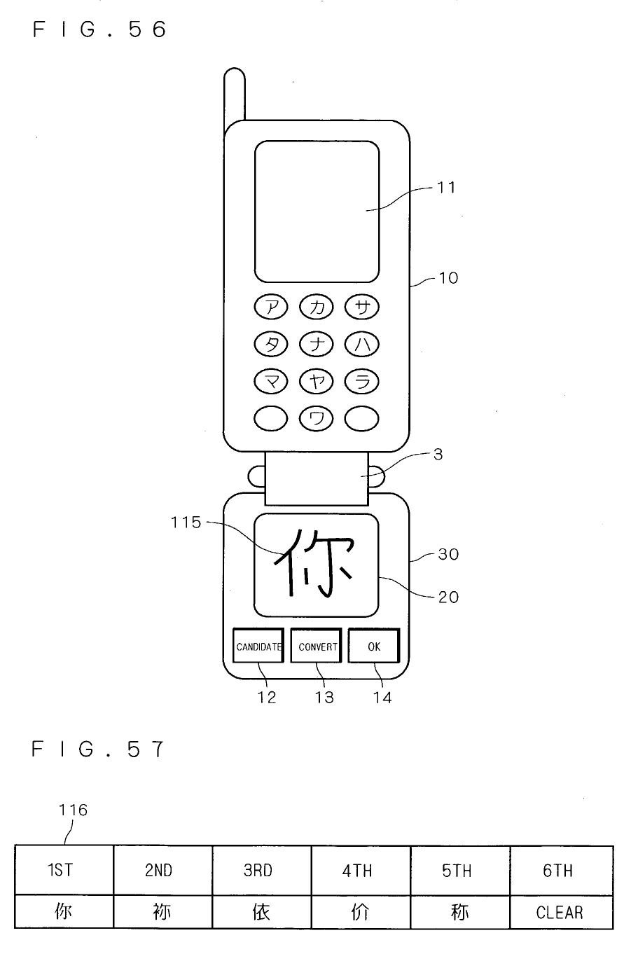

For instance, if characters similar to the handwritten character are of a plurality of character types as in the tenth preferred embodiment, the character recognition performed without the narrowing down of the character input mode might produce a character recognition result as shown in FIG. 53 which includes the Katakana character “he” as the top-ranked candidate character 107, the Hiragana character “he” as the second-ranked candidate character 108, and symbols or marks as other candidate characters, thus reducing the probability that the correct character intended by the user (Hiragana character “he”) is placed in the top rank. In such a case, limiting the character input mode provides the correct character recognition result.

Additionally, the tenth preferred embodiment uses the character input mode information to narrow down the characters to be subjected to the matching by the character recognition means 101, to achieve a high-speed character recognition process.

Eleventh Preferred Embodiment

FIG. 54 is a block diagram of the auxiliary input device according to an eleventh preferred embodiment of the present invention. As shown in FIG. 54, the auxiliary input device according to the eleventh preferred embodiment comprises the input section 20, a character recognition means 111, the connection section 3, an information acquisition means 110, and a control means 24k.

Referring to FIG. 54, the information acquisition means 110 collects character recognition dictionary information from the external device body. The character recognition means 111 performs character recognition based on the character recognition dictionary information acquired by the information acquisition means 110. The control means 24k controls the input section 20, the character recognition means 111, the connection section 3, and the information acquisition means 110. The character recognition dictionary information refers to information which specifies matching character patterns to be matched or compared with a character pattern serving as the writing information. The remaining structure of the eleventh preferred embodiment is similar to that of the first preferred embodiment shown in FIG. 1.

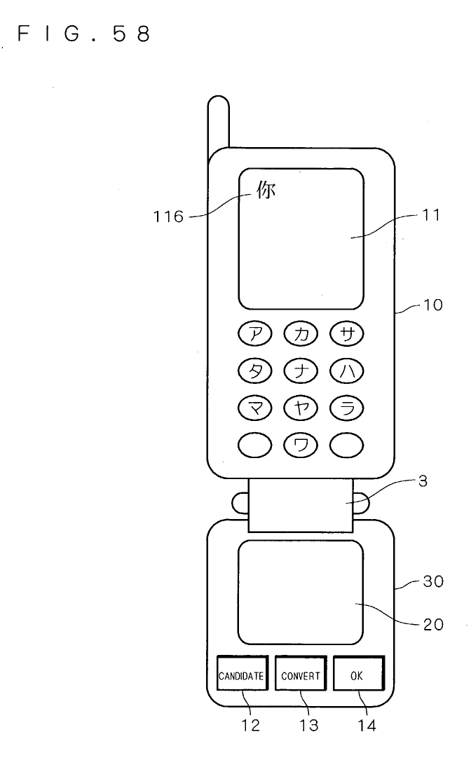

FIG. 55 is a flowchart showing the procedure of a handwriting input operation using the auxiliary input device according to the eleventh preferred embodiment. This process is performed under the control of the control means 24k. The precondition of the eleventh preferred embodiment is identical with that of the first to tenth preferred embodiments.

FIG. 56 illustrates a Chinese Kanji character as an input pattern 115 written on the input section 20.

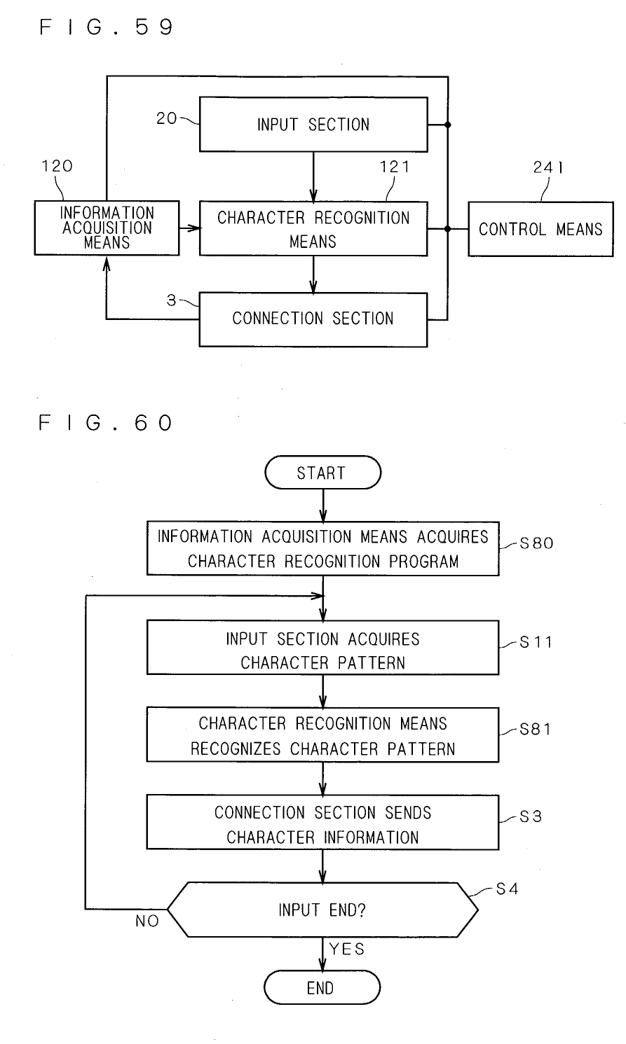

FIG. 57 illustrates candidate characters of a character recognition result recognized by the character recognition means 111. As illustrated in FIG. 57, Chinese Kanji characters including a top-ranked candidate character 116 are recognized.

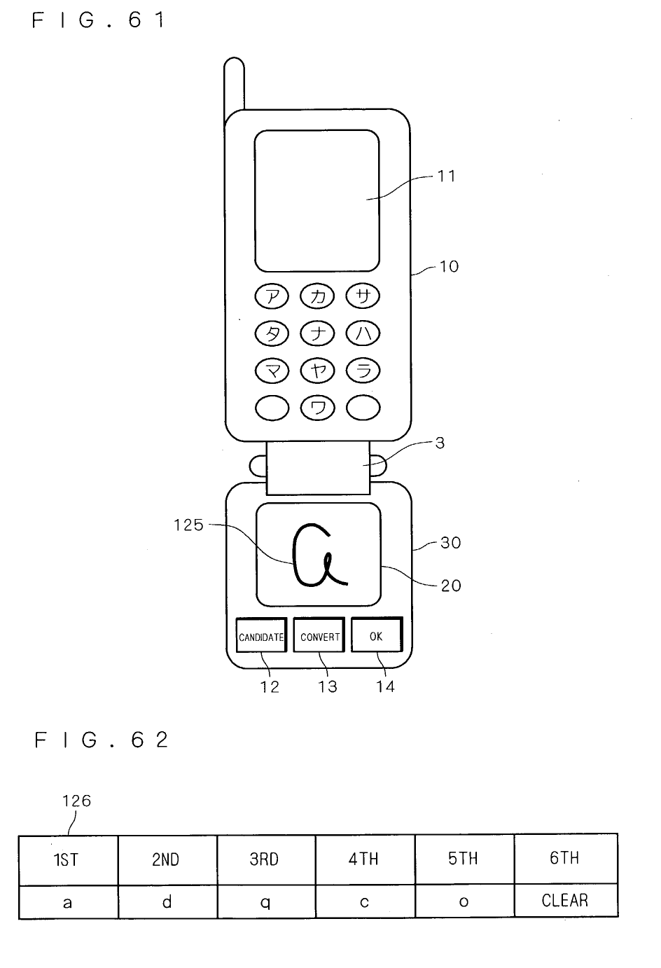

FIG. 58 illustrates a Chinese Kanji character displayed on the display screen 11 of the portable telephone 10 through the connection section 3. As illustrated in FIG. 58, the Chinese Kanji character which is the top-ranked candidate character 116 appears on the display screen 11. The eleventh preferred embodiment is based on the precondition that the portable telephone 10 has the function of displaying Chinese Kanji characters.

The operation of the eleventh preferred embodiment will be described with reference to the flowchart of FIG. 55. First, in Step S70, the control means 24k controls the information acquisition means 10 to acquire a character recognition dictionary from the external device to substitute the acquired character recognition dictionary for a character recognition dictionary provided in the character recognition means 111. In this preferred embodiment, it is assumed that the character recognition dictionary of Chinese (simplified characters) is acquired.

Next, in Step S11, the control means 24k controls the input section 20 to acquire a character pattern. It is assumed that the character pattern 115 which is a Chinese Kanji character is acquired, as shown in FIG. 56.

Then, in Step S71, the control means 24k sends the character pattern obtained by the input section 20 to the character recognition means 111, and the character recognition means 111 recognizes the character pattern using the substituted Chinese character recognition dictionary to output a character recognition result. In this preferred embodiment, it is assumed that the character recognition result shown in FIG. 57 is obtained.

Next, in Step S3, the control means 24k sends character information about the top-ranked candidate character included in the character recognition result obtained by the character recognition means 111 to the connection section 3, and the connection section 3 sends the character information to the portable telephone 10. In this preferred embodiment, the top-ranked candidate character 116 is sent to the portable telephone 10, and the Chinese Kanji character which is the top-ranked candidate character 116 is displayed on the display screen 11, as shown in FIG. 58.

Next, in Step S4, the control means 24k judges whether or not input is terminated. If input is not terminated, the process returns to Step S11. If input is terminated, the process is terminated.

Although the information acquisition means 110 substitutes the character recognition dictionary from the external device for the original character recognition dictionary provided in the character recognition means 111 in this preferred embodiment, the character recognition dictionary from the external device may be added to the original character recognition dictionary and be used.

As described above, the auxiliary input device according to the eleventh preferred embodiment comprises the information acquisition means 110 which acquires the character recognition dictionary from the external device to substitute the acquired character recognition dictionary for the original character recognition dictionary provided in the character recognition means 111. This allows free change between character types to be recognized, thereby to facilitate the recognition of multiple languages, high-accuracy recognition using dictionaries tailored to respective users, and the recognition of external or user-defined characters.

Twelfth Preferred Embodiment

FIG. 59 is a block diagram of the auxiliary input device according to a twelfth preferred embodiment of the present invention. As shown in FIG. 59, the auxiliary input device according to the twelfth preferred embodiment comprises the input section 20, a character recognition means 121, the connection section 3, an information acquisition means 120, and a control means 241.

Referring to FIG. 59, the information acquisition means 120 acquires a character recognition program which specifies a character recognition method to be carried out by the character recognition means 121 from the external device body. The character recognition means 121 performs character recognition based on the character recognition program acquired by the information acquisition means 120. The control means 241 controls the input section 20, the character recognition means 121, the connection section 3, and the information acquisition means 120.

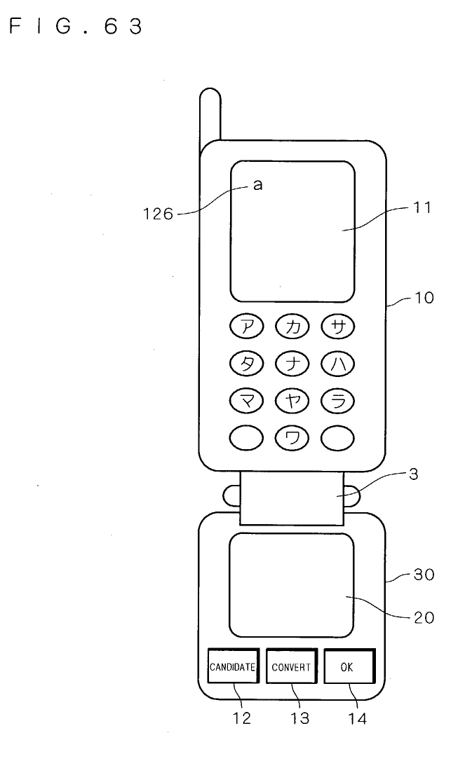

FIG. 60 is a flowchart showing the procedure of a handwriting input operation using the auxiliary input device according to the twelfth preferred embodiment. This process is performed under the control of the control means 241. The precondition of the twelfth preferred embodiment is identical with that of the first to eleventh preferred embodiments.

FIG. 61 illustrates a character pattern 125 (alphabetic character “a”) written on the input section 20.

FIG. 62 illustrates a character recognition result recognized by the character recognition means 121. As illustrated in FIG. 62, a top-ranked candidate character 126 and other candidate characters are recognized.

FIG. 63 illustrates the top-ranked candidate character 126 (alphabetic character “a”) displayed on the display screen 11 of the portable telephone 10 through the connection section 3.

The operation of the twelfth preferred embodiment will be described with reference to the flowchart of FIG. 60. First, in Step S80, the control means 241 controls the information acquisition means 120 to acquire a character recognition program from the external device to substitute the acquired character recognition program for a character recognition program provided in the character recognition means 121. In this preferred embodiment, it is assumed that the character recognition program for recognition of English characters is acquired.

Next, in Step S111, the control means 241 controls the input section 20 to acquire a character pattern. It is assumed that the character pattern 125 indicating an English character “a” is acquired, as shown in FIG. 61.

Then, in Step S81, the control means 241 sends the character pattern obtained by the input section 20 to the character recognition means 121, and the character recognition means 121 recognizes the character pattern using the substituted character recognition program for recognition of English characters to output a character recognition result. In this preferred embodiment, it is assumed that the character recognition result shown in FIG. 62 is obtained.

Next, in Step S3, the control means 241 sends character information about the top-ranked candidate character 126 included in the character recognition result obtained by the character recognition means 121 to the connection section 3, and the connection section 3 sends the character information to the portable telephone 10. In this preferred embodiment, the top-ranked candidate character 126 (alphabetic character “a”) is sent to the portable telephone 10, and is displayed on the display screen 11, as shown in FIG. 63.

Next, in Step S4, the control means 241 judges whether or not input is terminated. If input is not terminated, the process returns to Step S11. If input is terminated, the process is terminated.

Although the information acquisition means 120 substitutes the character recognition program acquired from the external device for the original character recognition program provided in the character recognition means 121 in this preferred embodiment, the character recognition program from the external device may be used coresident with the original character recognition program.

As described above, the auxiliary input device according to the twelfth preferred embodiment comprises the information acquisition means 120 which acquires the character recognition program from the external device to substitute the acquired character recognition program for the original character recognition program provided in the character recognition means 121. This allows the character recognition using a method suitable for recognition of characters for which requirements cannot be met by changing only the character recognition dictionary. The recognition of English characters as in the twelfth preferred embodiment reduces the capacity of the recognition program, as compared with the recognition of complicated characters such as Kanji characters, and accordingly allows the introduction of word information for use of character-to-character connection, character connection information, and the like. This achieves high-accuracy recognition based on a past character recognition history.

Thirteenth Preferred Embodiment

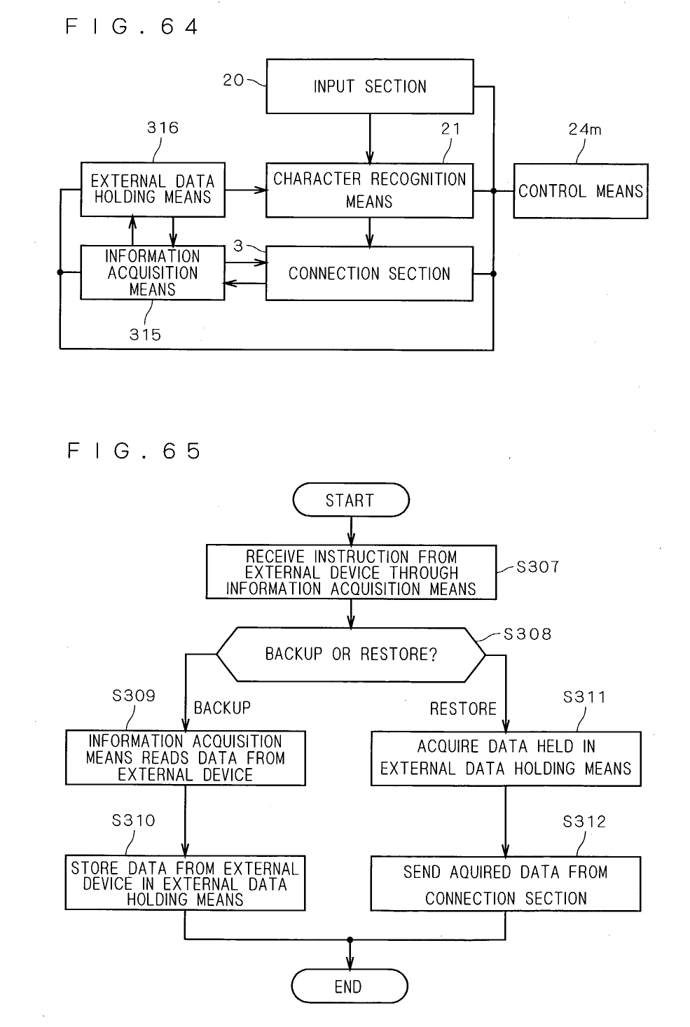

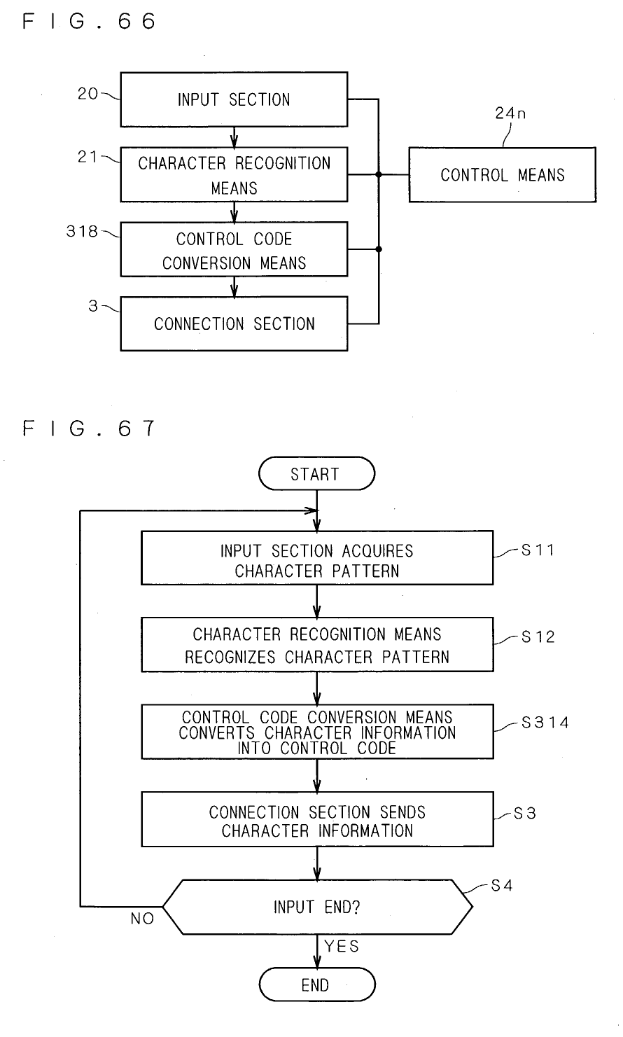

FIG. 64 is a block diagram of the auxiliary input device according to a thirteenth preferred embodiment of the present invention. As shown in FIG. 64, the auxiliary input device according to the thirteenth preferred embodiment comprises the input section 20, the character recognition means 21, the connection section 3, an external data holding means 316, an information acquisition means 315, and a control means 24m.

Referring to FIG. 64, the information acquisition means 315 reads a backup/restore instruction and data held in the external device body from the external device body. The external data holding means 316 holds therein the data from the external device body. The control means 24m controls the input section 20, the character recognition means 21, the connection section 3, the external data holding means 316, and the information acquisition means 315.

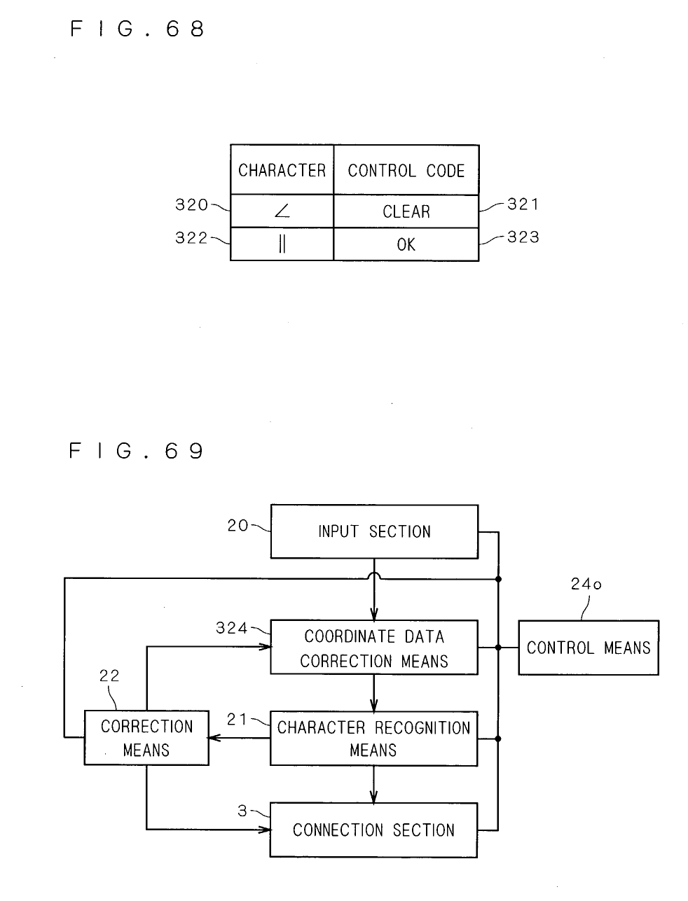

FIG. 65 is a flowchart showing the procedure of a handwriting input operation using the auxiliary input device according to the thirteenth preferred embodiment. This process is performed under the control of the control means 24m. The precondition of the thirteenth preferred embodiment is identical with that of the first to twelfth preferred embodiments.

The operation of the thirteenth preferred embodiment will be described with reference to the flowchart of FIG. 65. First, in Step S307, the control means 241 controls the information acquisition means 315 to receive an instruction from the external device.

Next, in Step S308, whether the received instruction is a backup instruction or a restore instruction is judged. If the backup instruction is received, the process proceeds to Step S309. If the restore instruction is received, the process proceeds to Step S311. The processing when the backup instruction is received will be first described.

If the backup instruction is received, the control means 24m instructs the information acquisition means 315 to read data from the external device, and the information acquisition means 315 reads the data from the external device through the connection section 3, in Step S309.

Next, in Step S310, the control means 24m sends the data from the external device which is obtained by the information acquisition means 315 to the external data holding means 316. The external data holding means 316 holds therein the data sent thereto.

The processing when it is judged in Step S308 that a restore process is to be performed will be described.

For the restore process, the control means 24m acquires the data held in the external data holding means 316, in Step S311.

Next, in Step S312, the control means 24m sends the acquired data to the connection section 3 which in turn sends the data to the external device. After the data is sent to the external device, the process is terminated.

As described above, the auxiliary input device according to the thirteenth preferred embodiment comprises the information acquisition means 315 and the external data holding means 316, and is capable of storing therein the data read from the external device or reading therefrom the stored data. Thus, the auxiliary input device has the function of making backup copies of the external device.

Fourteenth Preferred Embodiment

FIG. 66 is a block diagram of the auxiliary input device according to a fourteenth preferred embodiment of the present invention. As shown in FIG. 66, the auxiliary input device according to the fourteenth preferred embodiment comprises the input section 20, the character recognition means 21, a control code conversion means 318, the connection section 3, and a control means 24n.

Referring to FIG. 66, the control code conversion means 318 converts character information (or a character code) obtained from the character recognition means 21 into a control code. The control means 24n controls the input section 20, the character recognition means 21, the control code conversion means 318 and the connection section 3. The remaining structure of the fourteenth preferred embodiment is similar to that of the first preferred embodiment shown in FIG. 1.

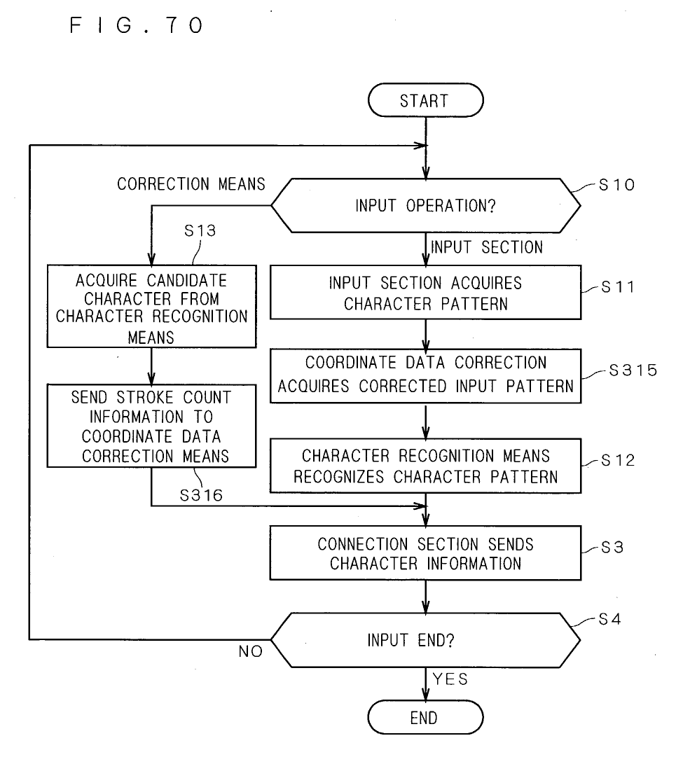

FIG. 67 is a flowchart showing the procedure of a handwriting input operation using the auxiliary input device according to the fourteenth preferred embodiment. This process is performed under the control of the control means 24n. The precondition of the fourteenth preferred embodiment is identical with that of the first to thirteenth preferred embodiments.

FIG. 68 illustrates an exemplary conversion table for use in the conversion process by the control code conversion means 318. As shown in FIG. 68, a control code indicating “clear” is assigned to a symbol 320 (“<”), and a control code indicating “OK” is assigned to a symbol 322 (“∥”).

The operation of the fourteenth preferred embodiment will be described with reference to the flowchart of FIG. 67. First, in Step S11, the control means 24n controls the input section 20 to acquire a character pattern. It is assumed that a character pattern of the symbol 322 (“∥”) shown in FIG. 68 is acquired.

Next, in Step S12, the control means 24n sends the character pattern obtained by the input section 20 to the character recognition means 21. The character recognition means 21 outputs characters of a recognition result.

Then, in Step S314, the control means 24n sends character information about the character recognition result obtained by the character recognition means 21 to the control code conversion means 318. The control code conversion means 318 refers to a conversion table as shown in FIG. 68 to output the control code indicating “OK” corresponding to the symbol 322 (“∥”).

Then, in Step S3, the control means 24n sends the control code indicating “OK” obtained from the control code conversion means 318 to the connection section 3, and the connection section 3 sends the control code as character information to the external device.

Next, in Step S4, the control means 24n judges whether or not input is terminated. If input is not terminated, the process returns to Step S11. If input is terminated, the process is terminated.

As described above, the auxiliary input device according to the fourteenth preferred embodiment comprises the control code conversion means 318, and is capable of sending a specific character as the control code to the external device. This achieves the auxiliary input device with high operability of the external device.

Fifteenth Preferred Embodiment

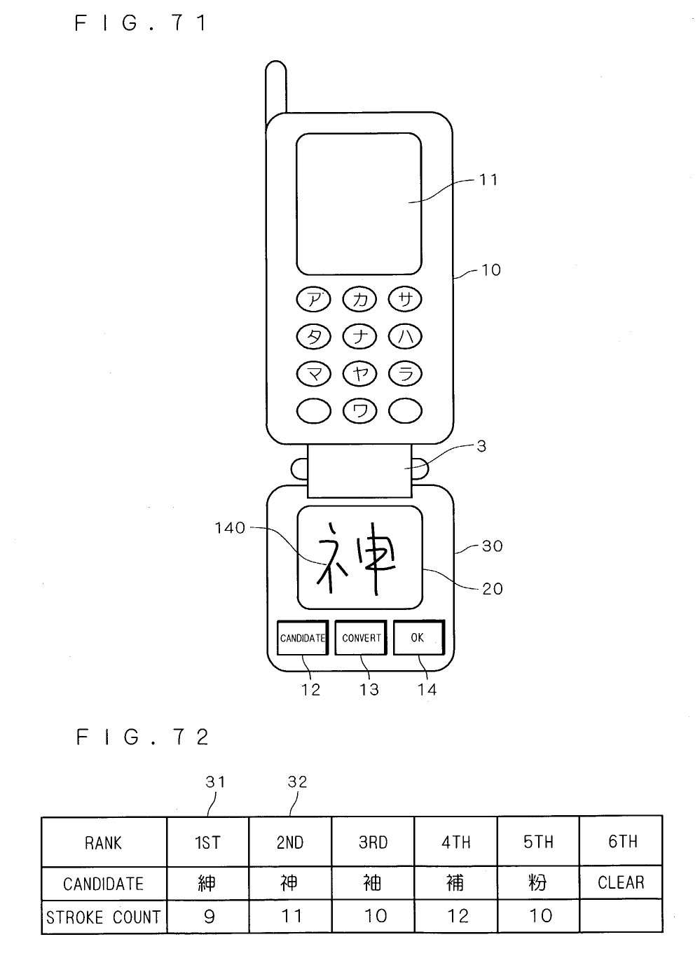

FIG. 69 is a block diagram of the auxiliary input device according to a fifteenth preferred embodiment of the present invention. As shown in FIG. 69, the auxiliary input device according to the fifteenth preferred embodiment comprises the input section 20, a coordinate data correction means 324, the character recognition means 21, the connection section 3, the correction means 22, and a control means 24o.

Referring to FIG. 69, the coordinate data correction means 324 corrects coordinate data based on the writing information (coordinate data and writing pressure data) from the input section 20. If the character recognition result is incorrect, the correction means 22 selects a correct character among a plurality of candidate characters included in the character recognition result to make a correction. The control means 24o controls the input section 20, the coordinate data correction means 324, the character recognition means 21, the connection section 3, and the correction means 22.

FIG. 70 is a flowchart showing the procedure of a handwriting input operation using the auxiliary input device according to the fifteenth preferred embodiment. This process is performed under the control of the control means 24o. The precondition of the fifteenth preferred embodiment is identical with that of the first to fourteenth preferred embodiments.

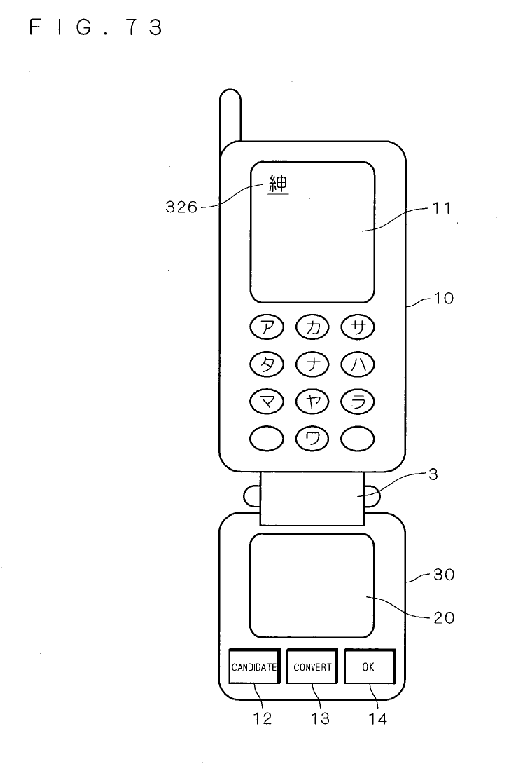

FIG. 71 illustrates a Kanji input pattern 140 written on the input section 20.

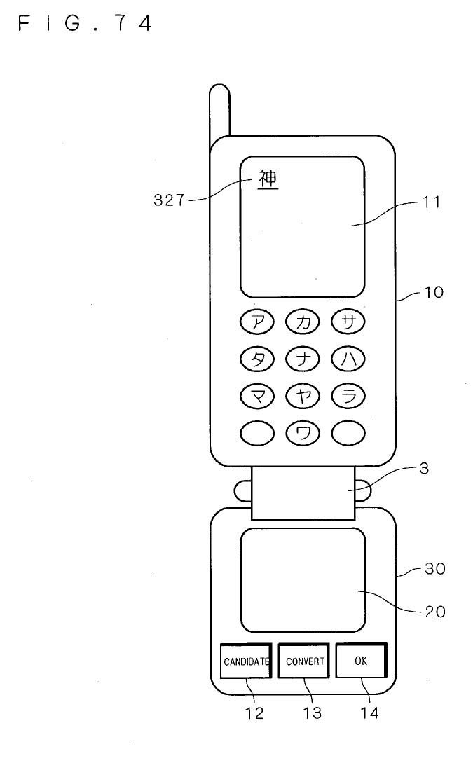

FIG. 72 illustrates a plurality of candidate characters of a recognition result recognized by the character recognition means 21, and their stroke counts.

FIG. 73 illustrates the top-ranked candidate character 326 of the recognition result displayed on the display screen 11 of the portable telephone 10 through the connection section 3.

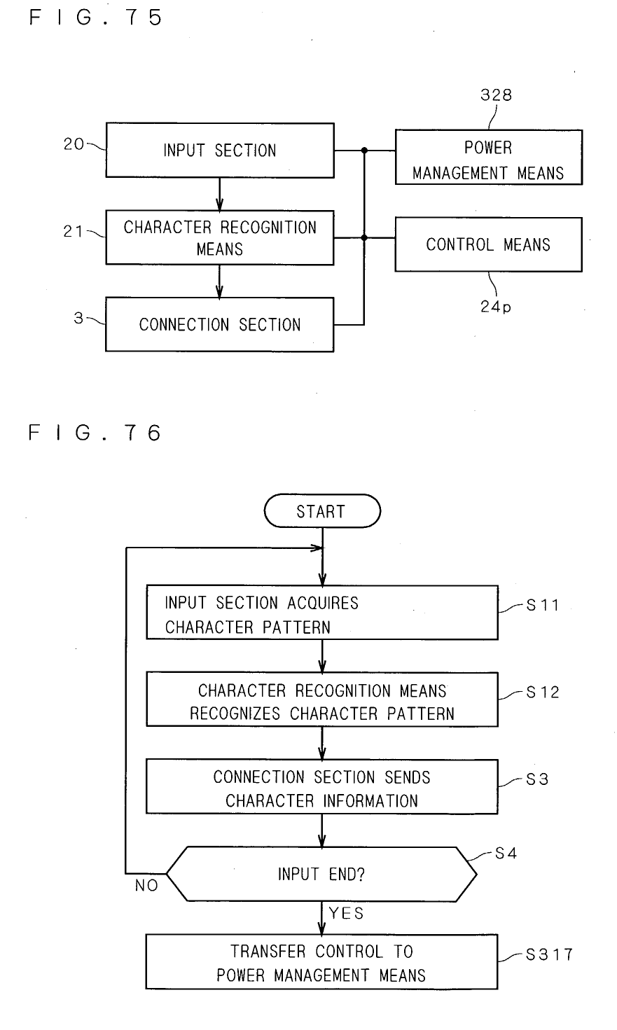

FIG. 74 illustrates the display screen 11 of the portable telephone 10 after the recognition result is corrected using the correction means 22.

The operation of the fifteenth preferred embodiment will be described with reference to the flowchart of FIG. 70. First, in Step S10, the control means 24o examines which means was used for input operation. If the correction means 22 was used, the process proceeds to Step S13. If the input section 20 was used, the process proceeds to Step S11. It is assumed in this preferred embodiment that the input section 20 was used first for handwriting and the process proceeds to Step S11.

In Step S11, the control means 24o controls the input section 20 to acquire an input pattern serving as the writing information. It is assumed that the character pattern 140 (Kanji character for the English word “god”) shown in FIG. 71 is acquired.

Next, in Step S315, the control means 24o sends the character pattern (with the writing pressure information) obtained by the input section 20 to the coordinate data correction means 324 to obtain a corrected character pattern. Using the writing pressure information included in the writing information, the coordinate data correction means 324 distinguishes between two states: a pen-down state when the writing pressure is not less than a threshold value P0, and a pen-up state when the writing pressure is less than the threshold value P0. Then, the coordinate data correction means 324 corrects the coordinate data.

Next, in Step S12, the control means 24o sends the corrected character pattern obtained by the coordinate data correction means 324 to the character recognition means 21. The character recognition means 21 outputs a character recognition result. It is assumed in this preferred embodiment that the character recognition result shown in FIG. 72 is obtained.

Next, in Step S3, the control means 24o sends character information about the top-ranked candidate character included in the character recognition result obtained by the character recognition means 21 to the connection section 3, and the connection section 3 sends the character information about the top-ranked candidate character to the portable telephone 10. In this preferred embodiment, the character information about the top-ranked candidate character 326 (Kanji character for the English word “dignitary”) is sent to the portable telephone 10, and the top-ranked candidate character 326 is displayed on the display screen 11 of the portable telephone 10, as shown in FIG. 73.

Next, in Step S4, the control means 24o judges whether or not input is terminated. It is assumed that input is not terminated and the process returns to Step The input operation is judged in Step S10. In this preferred embodiment, the top-ranked candidate character 326 (Kanji character for the English word “dignitary”) of the character recognition result displayed on the display screen 11 of the portable telephone 10 is an incorrect character. Then, it is assumed that the user presses the candidate button 12 of the correction means 22 to select the second-ranked candidate character, and the process proceeds to Step S13.

In Step S13, the control means 24o controls the correction means 22 which in turn acquires the second-ranked candidate character and its stroke count information from the character recognition means 21.

Next, in Step S316, it is assumed that the user presses the OK button 14 to select the second-ranked candidate character 32 (Kanji character for the English word “god”). In response to this selection, the control means 24o controls the correction means 22 which in turn sends the stroke count information about the selected second-ranked candidate character 32 to the coordinate data correction means 324. The coordinate data correction means 324 compares the stroke count sent from the correction means 22 with the stroke count (already held therein) of the previously corrected coordinate data. If the stroke count of the previously corrected coordinate data is greater than the stroke count sent from the correction means 22, the coordinate data correction means 324 changes the writing pressure threshold value P0 to P1 (<P0) so as to use the new threshold value P1 for the subsequent coordinate data correction process. In other words, the coordinate data correction means 324 changes the coordinate data obtained from the writing information, based on the character feature information or the stroke count information about the character selected by the correction means 22.

Then, in Step S3, the control means 24o gives an instruction to the correction means 22, and the correction means 22 sends a character string including a control code indicating one-character deletion and the selected character information to the connection section 3. The connection section 3 sends the character string as the sending information to the portable telephone 10. In this preferred embodiment, the control code indicating one-character deletion is sent to the portable telephone 10, thereby to cause the top-ranked candidate character 326 (Kanji character for the English word “dignitary”) shown in FIG. 73 to be deleted. Then, the second-ranked candidate character 327 (Kanji character for the English word “god”) is sent to the portable telephone 10, thereby to cause the second-ranked candidate character 327 (Kanji character for the English word “god”) to be displayed on the display screen 11 of the portable telephone 10, as shown in FIG. 74. Thus, the correction process provides the correct character.

Next, in Step S4, the control means 24o judges whether or not input is terminated. It is assumed that input is terminated and the process is terminated.

As described above, the auxiliary input device according to the fifteenth preferred embodiment comprises the coordinate data correction means 324, and is capable of dynamically adjusting the recognition parameter of the coordinate data correction means 324. This provides the auxiliary input device capable of flexibly handling a difference in sensitivity characteristic of the input means between products and a difference in writing pressure between users.

Sixteenth Preferred Embodiment

FIG. 75 is a block diagram of the auxiliary input device according to a sixteenth preferred embodiment of the present invention. As shown in FIG. 75, the auxiliary input device according to the sixteenth preferred embodiment comprises the input section 20, the character recognition means 21, the connection section 3, a power management means 328, and a control means 24p.

Referring to FIG. 75, the power management means 328 controls whether to place the entire auxiliary input device into a normal operating state or a standby state for low power consumption. The control means 24p controls the input section 20, the character recognition means 21, the connection section 3 and the power management means 328. The remaining structure of the sixteenth preferred embodiment is similar to that of the first preferred embodiment shown in FIG. 1.

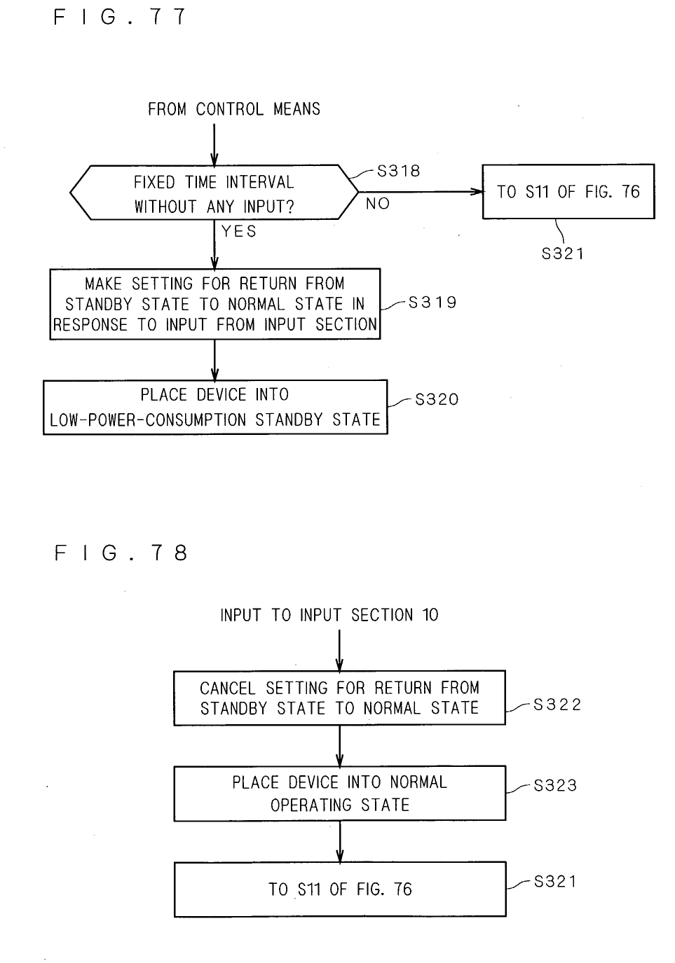

FIG. 76 is a flowchart showing the procedure of a handwriting input operation using the auxiliary input device according to the sixteenth preferred embodiment. This process is performed under the control of the control means 24p. The precondition of the sixteenth preferred embodiment is identical with that of the first to fifteenth preferred embodiments.

FIG. 77 is a flowchart showing a flow of the process of transitioning from the normal operating state to the low-power-consumption standby state.

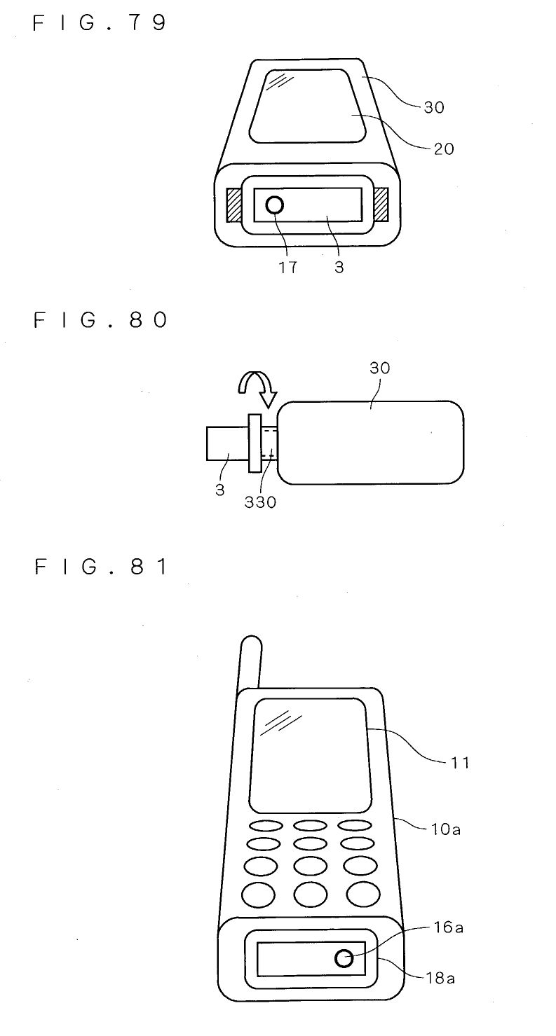

FIG. 78 is a flowchart showing a flow of the process of transitioning from the low-power-consumption standby state to the normal operating state.

The operation of the sixteenth preferred embodiment will be described with reference to the flowchart of FIG. 76. Steps S11, S12 and S3 of the sixteenth preferred embodiment are similar in operation to those of the first preferred embodiment.

Next, in Step S4, the control means 24p judges whether or not input is terminated. It is assumed that input is terminated and the process proceeds to Step S317.

In Step S317, the control means 24p gives an instruction to the power management means 328, and transfers control to the power management means 328.

The processing after control is transferred to the power management means 328 will be described with reference to the flowchart of FIG. 77.

Referring to FIG. 77, in Step S318, the power management means 328 checks whether or not there is a continuous fixed time interval during which no input is done to the input section 20. If there is an input to the input section 20 during the fixed time interval, the process proceeds to Step S321 in which control is transferred to the control means 24p and the process returns to Step S11 in the flowchart of FIG. 76. If there is no input during the fixed time interval in Step S318, the process proceeds to Step S319.

In Step S319, the power management means sets a method of returning from the standby state to the normal state. In this example, the setting is made so that an input from the input section 20 causes the return to the normal state.

Next, in Step S320, the entire auxiliary input device is placed into the low-power-consumption standby state. All of the elements shown in FIG. 75 stop their operations except for the standby process of the power management means 328.

The operation of the power management means 328 for transition from the normal operating state to the low-power-consumption standby state is described above.

The transition from the low-power-consumption standby state to the normal operating state will be described with reference to FIG. 78.

If an input is done from the input section 20 in the standby state, the power management means 328 performs the process starting from Step S322 of FIG. 78. In Step S322, the setting of the method of returning from the stand-by state to the normal operating state is canceled.

Next, in Step S323, the power management means 328 places the auxiliary input device into the normal operating state.

Then, in Step S321, the power management means 328 transfers control to the control means 24p, and the process returns to Step S11.

The processes in Step S11 of FIG. 76 and its subsequent steps are similar to those of the first preferred embodiment described above.

The sixteenth preferred embodiment is described hereinabove. Although the setting is made so that an input from the input section 20 causes the return from the standby state in the sixteenth preferred embodiment, a press of the button of the correction means 22 and the like may cause the return.

As described above, the auxiliary input device according to the sixteenth preferred embodiment comprises the power management means 328 which places the auxiliary input device into the low-power-consumption standby state after the expiration of the continuous fixed time interval during which no input is done. This reduces the power consumption, and increases the operating time of the auxiliary input device if the device is battery-operated.

Seventeenth Preferred Embodiment

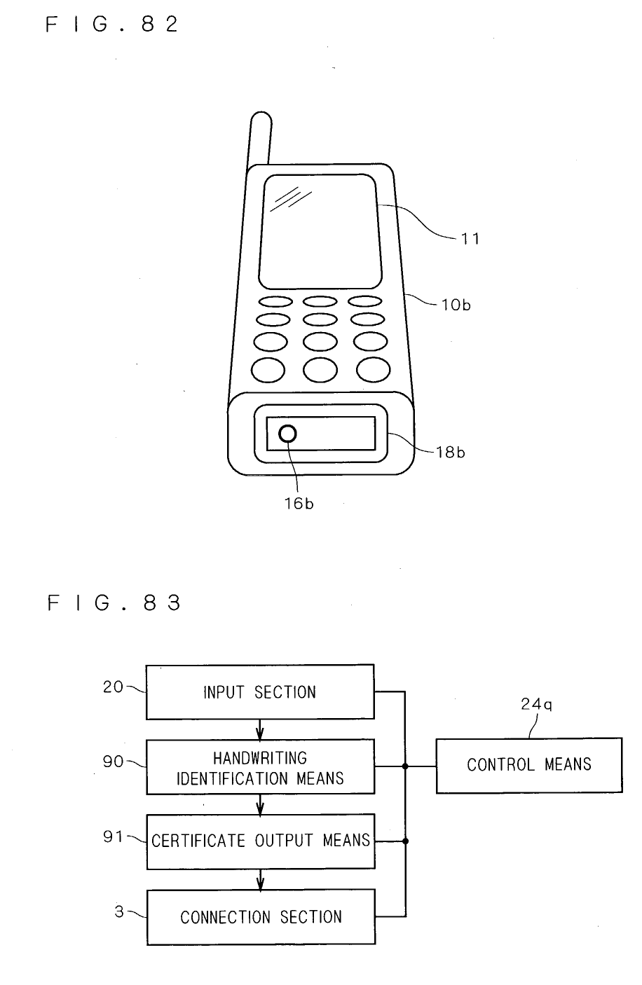

FIGS. 79 and 80 illustrate the connection section 3 and its surroundings according to a seventeenth preferred embodiment of the present invention. As shown in FIGS. 79 and 80, the connection section 3 has a rotation mechanism 330 provided therein and free to rotate, and a recess 17 on the left-hand side, as viewed in FIG. 79.

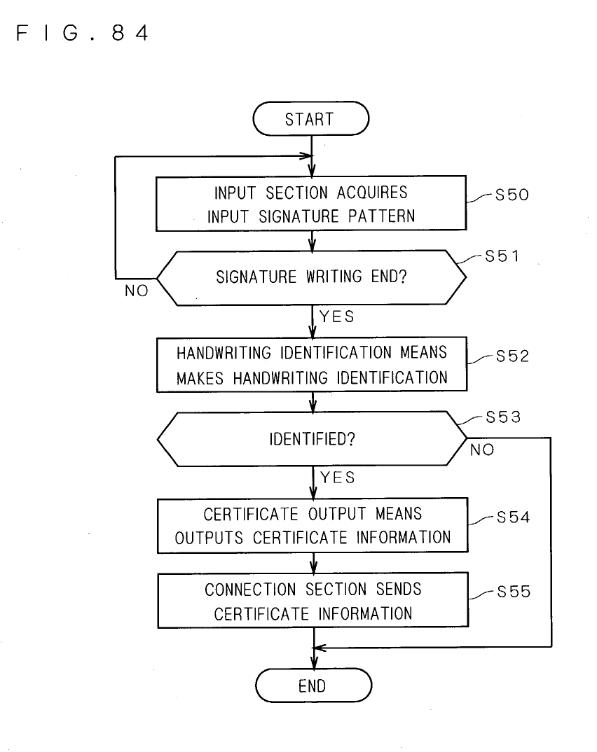

FIG. 81 illustrates a first example of the portable telephone. FIG. 82 illustrates a second example of the portable telephone. As illustrated in FIGS. 81 and 82, there is a difference in connector orientation between the portable telephones 10a and 10b. Specifically, assuming that the surface of the portable telephone including the display screen 11 is an upper surface, the portable telephone 10a has a protrusion 16a on the right-hand side of a connector 18a for fitting into the recess 17 of the connection section 3, whereas the portable telephone 10b has a protrusion 16b on the left-hand side of a connector 18b.

The auxiliary input device 30 will be connected to the portable telephone 10a shown in FIG. 81 in a manner to be described below. The connector of the connection section 3 has the configuration shown in FIG. 79. Thus, no problem occurs if the connection section 3 is connected to the portable telephone 10a shown in FIG. 81, with the connector of the connection section 3 held in the orientation shown in FIG. 79 because the display screen 11 and the input section 20 face in the same direction.

On the other hand, the auxiliary input device 30 will be connected to the portable telephone 10b shown in FIG. 82 in a manner to be described below. If the connection section 3 is connected to the portable telephone 10b shown inn FIG. 82, the display screen 11 and the input section 20 are 180 degrees away from each other and do not face in the same direction. Thus, the user cannot view both the display screen 11 and the input section 20 at the same time to enter a character.

However, the auxiliary input device 30 according to the seventeenth preferred embodiment comprises the connection section 3 having the rotation mechanism 330. The user may rotate the rotation mechanism 330 to rotate the orientation of the connection section 3 of the auxiliary input device 30 through 180 degrees. Connecting the auxiliary input device 30 to the portable telephone 10b through the connection section 3 after the rotation through 180 degrees allows the display screen 11 and the input section 20 to face in the same direction.

As described above, the seventeenth preferred embodiment features the rotation mechanism 330 provided in the connection section 3 to achieve the auxiliary input device capable of being used for portable telephones of the types having different connector orientations.

Eighteenth Preferred Embodiment

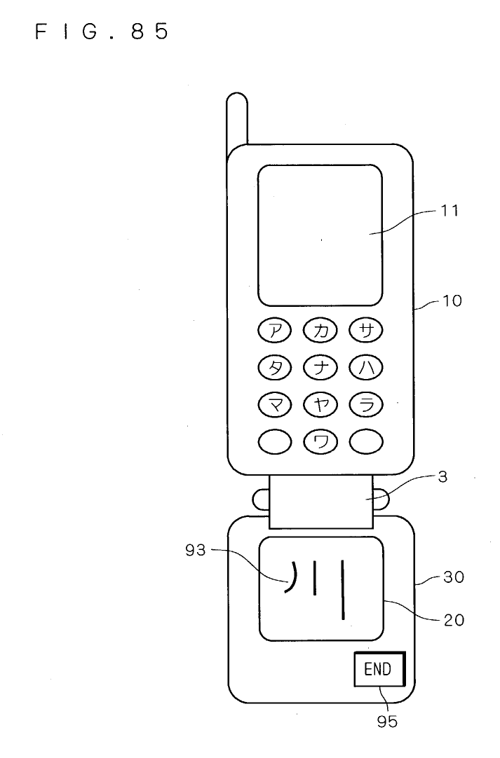

FIG. 83 is a block diagram of the auxiliary input device according to an eighteenth preferred embodiment of the present invention. As shown in FIG. 83, the auxiliary input device according to the eighteenth preferred embodiment comprises the input section 20, a handwriting identification means 90, a certificate output means 91, the connection section 3, and a control means 24q.

Referring to FIG. 83, the handwriting identification means 90 judges the identity of a writer, based on a character pattern (handwriting information) obtained by the input section 20. If the result of identification by the handwriting identification means 90 is acceptable, the certificate output means 91 outputs certificate information which certifies that the result of identification satisfies a predetermined condition. The control means 24q controls the input section 20, the handwriting identification means 90, the certificate output means 91, and the connection section 3. The remaining structure of the eighteenth preferred embodiment is similar to that of the first preferred embodiment shown in FIG. 1.

FIG. 84 is a flowchart showing the procedure of a signature identification process using the auxiliary input device according to the eighteenth preferred embodiment. This process is performed under the control of the control means 24q. The precondition of the eighteenth preferred embodiment is identical with that of the first to sixteenth preferred embodiments.

FIG. 85 illustrates the first character of a signature written on the input section 20. As shown in FIG. 85, an input signature pattern 93 (Kanji character for the English word “river”) is inputted to the input section 20. Pressing an end button 95 determines the end of the signature writing.

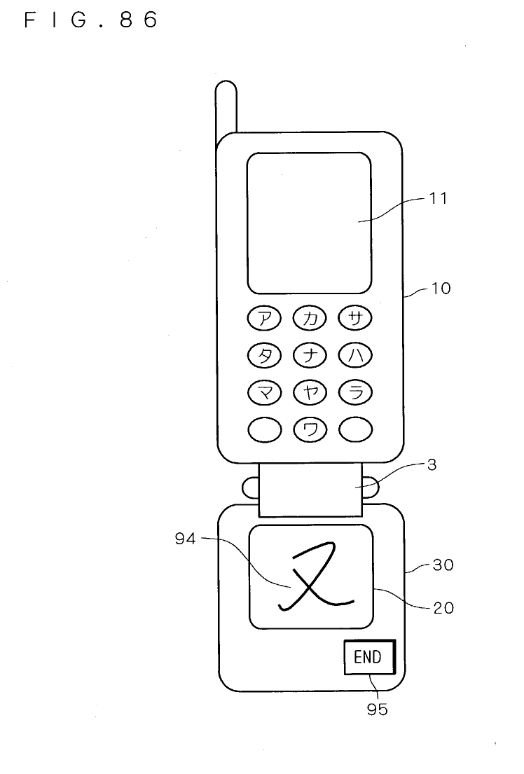

FIG. 86 illustrates the second character of the signature written on the input section 20. As shown in FIG. 86, an input signature pattern 94 (Kanji character for the English word “again”) is inputted to the input section 20.

The operation of the eighteenth preferred embodiment will be described with reference to the flowchart of FIG. 84. First, in Step S50, the control means 24q controls the input section 20 to acquire a character pattern as an input signature pattern. It is assumed that the input signature pattern 93 (Kanji character for the English word “river”) of a signature shown in FIG. 85 is acquired.

Next, in Step S51, the control means 24q judges whether or not signature writing is terminated. If signature writing is terminated, the process proceeds to Step S52. If signature writing is not terminated, the process returns to Step S50. Whether or not signature writing is terminated is determined depending on whether or not the end button 95 is pressed. It is assumed in this example that the end button 95 is not pressed, and the process returns to Step S50.

Next, in Step S50, the control means 24q controls the input section 20 to acquire input signature pattern information. It is assumed that the input signature pattern 94 (Kanji character for the English word “again”) of the second character of the signature shown in FIG. 86 is acquired.

Then, in Step S51, the control means 24q judges whether or not signature writing is terminated. If signature writing is terminated, the process proceeds to Step S52. If signature writing is not terminated, the process returns to Step S50. It is assumed in this example that writing the signature comprised of the two characters (Kanji characters for the English words “river” and “again”) is terminated and the end button 95 is pressed. Then, the process proceeds to Step S52.

Next, in Step S52, the control means 24q sends the input signature patterns 93 (Kanji character for the English word “river”) and 94 (Kanji character for the English word “again”) obtained by the input section 20 to the handwriting identification means 90. The handwriting identification means 90 compares the input signature patterns 93 and 94 with previously stored reference signature information (or reference signature patterns) about the writer's authentic signature, to judge whether or not the input signature patterns 93 and 94 are in the writer's own handwriting. The method of handwriting identification used herein is disclosed, for example, in Japanese Patent Application Laid-Open No. 11-238131 (1999) entitled “Handwriting Identification Device.”

Next, in Step S53, if the result of identification by the handwriting identification means 90 is “OK” (or acceptable), the answer to Step S53 is “YES” and the process proceeds to Step S54. If the result of identification is not “OK,” the answer to Step S53 is “NO” and the control means 24q terminates the processing. It is assumed in this example that the result of identification is “OK” and the process proceeds to Step S54.

In Step S54, the control means 24q controls the certificate output means 91 to output the certificate information previously stored therein in accordance with the result of identification.

Then, in Step S55, the control means 24q gives an instruction to the connection section 3 to send the certificate information outputted from the certificate output means 91 through the connection section 3 to the external device.

The eighteenth preferred embodiment is described above. The signature information is written on a character-by-character basis in the eighteenth preferred embodiment. However, the user may actually write the signature information continuously, in which case the input section 20 need not particularly detect the separation between characters, but the characters written before the end button is pressed are collected as a single signature.

Although signature writing is terminated by pressing the end button in this preferred embodiment, signature writing is judged as terminated after the expiration of a continuous fixed time interval during which the input section 20 is not written.

As described above, the auxiliary input device according to the eighteenth preferred embodiment comprises the handwriting identification means for judging the identity of the writer from the signature information, and the certificate output means for outputting the certificate information in accordance with the result of identification by the handwriting identification means. Thus, the auxiliary input device can judge the identity of the writer each time the certificate information is issued, thereby to accomplish the issue of certificates with a high level of security.

Additionally, the output of the certificates is performed by the auxiliary input device in the eighteenth preferred embodiment. This allows electronic commerce with a high level of security by means of portable telephones and other devices capable of being connected to the auxiliary input device.

While the invention has been described in detail, the foregoing description is in all aspects illustrative and not restrictive. It is understood that numerous other modifications and variations can be devised without departing from the scope of the invention.

What is claimed is:

1. An auxiliary input device comprising:
an input section for inputting writing information about a position in which a writing medium is brought into contact with a predetermined contact surface thereof;
a character recognition means for recognizing a character based on said writing information to provide a character recognition result; and
a connection section connectable to a predetermined external device for sending, to said predetermined external device, sending information including information about said character recognition result when said connection section is connected to said predetermined external device.

2. The auxiliary input device according to claim 1, wherein
said character recognition result includes a plurality pieces of candidate character information, and
said sending information includes top priority character information having the highest priority of said plurality of pieces of candidate character information.

3. The auxiliary input device according to claim 2, further comprises
a character selection means capable of selecting one piece of character information as selected character information among said plurality of pieces of candidate character information in response to user's manipulation of a predetermined manipulation section, wherein
said sending information includes said selected character information.

4. The auxiliary input device according to claim 3, further comprising
a character code generation means for generating a character code for use by said predetermined external device, based on one of said top priority character information and said selected character information, wherein
said sending information includes said character code.

5. The auxiliary input device according to claim 1, wherein
said character recognition result includes a plurality of character recognition results,
said auxiliary input device further comprising
a storage means capable of storing said plurality of character recognition results, wherein
said sending information includes information about said plurality of character recognition results.

6. The auxiliary input device according to claim 2, further comprising:
a writing medium determination means for determining the type of said writing medium, based on said writing information; and
a candidate character rearrangement means for changing the order of priority of said plurality of pieces of candidate character information included in said character recognition result, based on a result of determination of said writing medium determination means.

7. The auxiliary input device according to claim 1, wherein
said sending information includes said writing information itself.

8. The auxiliary input device according to claim 1, wherein
said writing information includes a plurality of coordinate data for specifying the position in which said writing medium is brought into contact with said predetermined contact surface,
said auxiliary input device further comprising
a coordinate code generation means for generating a plurality of coordinate codes for use by said predetermined external device, based on said plurality of coordinate data, wherein
said sending information includes said plurality of coordinate codes.

9. The auxiliary input device according to claim 8, wherein
said plurality of coordinate data include absolute coordinate data in a coordinate space using said predetermined contact surface as a coordinate plane.

10. The auxiliary input device according to claim 8, wherein
said plurality of coordinate data include relative coordinate data between two coordinate data successive in a writing direction.

11. The auxiliary input device according to claim 1, wherein
said writing information includes writing pressure data about a writing pressure in the position in which said writing medium is brought into contact with said predetermined contact surface, and
said sending information includes said writing pressure data.

12. The auxiliary input device according to claim 1, further comprising
a character type information acquisition means for acquiring character type information to be recognized by said character recognition means, wherein
said character recognition means narrows down a character type to be recognized, depending on said character type information, to provide said character recognition result.

13. The auxiliary input device according to claim 1, further comprising
a dictionary acquisition means for externally acquiring a character recognition dictionary to be used in said character recognition means, said character recognition dictionary specifying character patterns to be recognized, wherein
said character recognition means uses said character recognition dictionary to provide said character recognition result.

14. The auxiliary input device according to claim 1, further comprising
a program acquisition means for externally acquiring a character recognition program to be used in said character recognition means, said character recognition program specifying a character recognition method for providing said character recognition result, wherein
said character recognition means uses said character recognition program to provide said character recognition result.

15. The auxiliary input device according to claim 1, further comprising:
an external data holding means having a data holding function; and
an external data passing means capable of performing a data holding operation for causing said external data holding means to hold input data obtained from said predetermined external device through said connection section, and a data output operation for outputting data held in said external data holding means to said predetermined external device through said connection section.

16. The auxiliary input device according to claim 1, further comprising
a control code conversion means receiving said character recognition result for converting a character recognized as said character recognition result into a corresponding control code if said recognized character is a predetermined control character, wherein
said sending information includes said control code.

17. The auxiliary input device according to claim 3, wherein
said selected character information includes character feature information indicating a feature of a character,
said auxiliary input device further comprising
a writing information correction means for correcting said writing information based on said character feature information.

18. The auxiliary input device according to claim 1, further comprising
a power management means for performing a low power consumption operation after expiration of a continuous fixed time interval during which said writing medium is out of contact with said predetermined contact surface of said input section.

19. The auxiliary input device according to claim 1, wherein
said connection section includes a position changing section capable of changing a positional relationship between a predetermined surface of said predetermined external device and said predetermined contact surface through at least 180 degrees when said connection section is connected to said predetermined external device.

20. The auxiliary input device according to claim 1, further comprising
a handwriting identification means for comparing said writing information with previously prepared reference information to make a handwriting identification.

21. The auxiliary input device according to claim 20, further comprising
a certification information output means for outputting certification information for certifying that a result of the handwriting identification by said handwriting identification means satisfies a predetermined condition.
